(19) United States
(12) Patent Application Publication
(10) Pub. No.: US 2026/0193413 A1
(43) Pub. Date: Jul. 9, 2026

(54) MELAMINE-CONTAINING CO-POLYIMIDE MEMBRANES FOR NATURAL GAS SEPARATION

(71) Applicant: Saudi Arabian Oil Company, Dhahran (SA)

(72) Inventors: Junyan Yang, Cambridge, MA (US); Sheng Guo, Cambridge, MA (US); Yi Ren, Cambridge, MA (US); Patrick T. Wright, Cambridge, MA (US); Elizabeth E. Haddad, Cambridge, MA (US); Dana A. Wong, Cambridge, MA (US); Sibo Lin, Cambridge, MA (US); Xuezhen Wang, Cambridge, MA (US)

(21) Appl. No.: 19/013,466

(22) Filed: Jan. 8, 2025

(51) Int. Cl. C08G 73/10; B01D 53/22; B01D 67/00

(52) U.S. Cl. CPC C08G 73/1014; B01D 53/228; B01D 67/0002; B01D 2257/504; B01D 2323/081; B01D 2323/52

(57) ABSTRACT

This disclosure relates to melamine-containing copolyimides that incorporate a melamine moiety. This disclosure also relates to melamine-containing copolyimide membranes that can be used in natural gas separation and purification applications.

### TECHNICAL FIELD

The present disclosure relates to melamine-containing copolyimides and to membranes containing the melamine-containing copolyimides. The present disclosure also relates to methods of preparing and using the membranes for sour natural gas purification applications.

### BACKGROUND

Natural gas is a clean, reliable, and affordable energy source that can help reduce greenhouse gas emissions and meet growing energy demands. However, many natural gas reserves contain large amounts of acid gases like hydrogen sulfide (H₂S) and carbon dioxide (CO₂), which can corrode pipelines and pose safety risks. To make natural gas suitable for transport and sale, it must be sweetened by removing these acid gases. Liquid amine scrubbing is a common method for this. However, this process is energy-intensive, requires large amounts of chemical solvents, and involves complex equipment, making it costly for purifying sour natural gas with high concentrations of H₂S and CO₂.

Polyimide membranes functionalized with groups such as alkyl, amine, or acyl have been developed; however, these membranes often face a trade-off between permeability and selectivity and do not exhibit both favorable diffusivity and solubility, thus limiting their applications in natural gas separation and purification. Furthermore, incorporating units with high CO₂ affinity, like melamine, into the polyimide scaffold has been challenging due to the low nucleophilicity of melamine in the polycondensation reaction, which is a result of the electron-deficient aromatic 1,3,5-triazine ring. This characteristic makes it difficult to incorporate melamine-containing diamine monomers into the polycondensation process between dianhydrides and diamines. Additionally, melamine-containing polyimides are highly hydrophilic and exhibit low solubility in commonly used organic solvents due to the high polarity of the melamine units. As a result, their use in membrane-based sour natural gas separation has not been explored.

Accordingly, there is a need for melamine-containing polyimide-based membranes that can be used for sour natural gas purification applications, exhibiting enhanced separation performance and improved diffusivity of gas molecules through the membrane.

### SUMMARY

In an exemplary embodiment, a melamine-containing copolyimide contains a structural repeat unit of Formula (I):

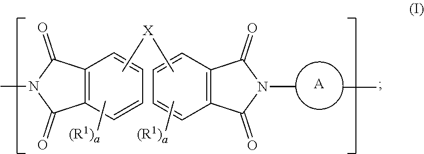

and
a structural repeat unit of Formula (II):

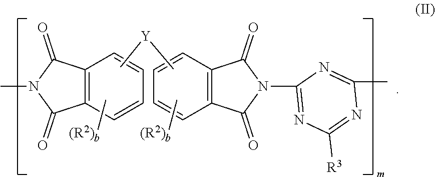

In some embodiments, Ring moiety A is selected from phenylene, biphenylene, terphenylene, and polycyclic aromatic hydrocarbon, wherein the phenylene, biphenylene, terphenylene, and polycyclic aromatic hydrocarbon are each optionally substituted with one, two, three, or four independently selected R⁴. In some embodiments, X and Y are each independently selected from a bond, —O—, —C(O)—, —O-phenyl-C₁₋₄ alkylene-phenyl-O—, and C₁₋₄ alkylene optionally substituted with one, two, three, or four independently selected R⁵. In some embodiments, each R¹ and R² is independently selected from halo, C₁₋₄ alkyl, and C₁₋₄ haloalkyl. In some embodiments, R³ is selected from H, —OH, halo, C₁₋₆ alkyl, C₁₋₆ haloalkyl, phenyl, C₁₋₄ alkyl-phenyl, C₃₋₂₀ cycloalkyl, C₆₋₂₀ aryl, C₆₋₂₀ heteroaryl, C₆₋₂₀ heterocycloalkyl, and —NR^{a}R^{b}, wherein R^{a} and R^{b} are each independently selected from H and C₁₋₆ alkyl, wherein the C₁₋₄ alkyl-phenyl, C₃₋₂₀ cycloalkyl, C₆₋₂₀ aryl, C₆₋₂₀ heteroaryl, and C₆₋₂₀ heterocycloalkyl are each optionally substituted with one, two, three, or four independently selected R⁶. In some embodiments, each R⁴, R⁵, and R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃. In some embodiments, a and b are each independently 0, 1, 2, or 3. In some embodiments, and m+n=1.

In some embodiments, Ring moiety A is phenylene optionally substituted with one, two, three, or four independently selected R⁴.

In some embodiments, each R⁴ is independently C₁₋₄ alkyl.

In some embodiments, X and Y are each methyl, each optionally substituted with one or two R⁵.

In some embodiments, each R⁵ is independently C₁ alkyl optionally substituted with one, two, or three R⁷, and each R⁷ is independently halo.

In some embodiments, X and Y are each methyl, wherein each methyl is substituted with two —CF₃.

In some embodiments, R³ is selected from H, —OH, halo, C₁₋₄ alkyl, phenyl, C₁₋₄ alkyl-phenyl, and C₆₋₂₀ heterocycloalkyl, wherein the C₁₋₄ alkyl-phenyl and C₆₋₂₀ heterocycloalkyl are each substituted with one, two, three, or four independently selected R⁶.

In some embodiments, wherein a and b are each independently 0 or 1.

In some embodiments, m is between 0.05 to 0.2, and n is between 0.8 to 0.95.

In some embodiments, the melamine-containing copolyimide has a Formula (III):

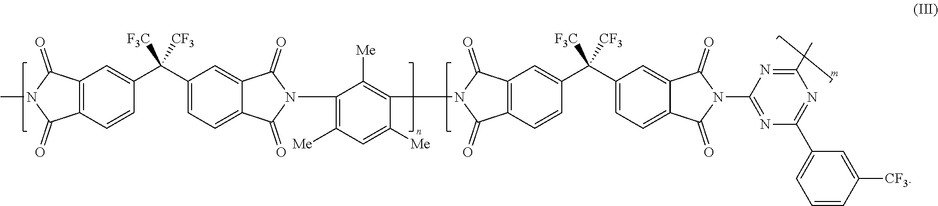

In some embodiments, m is 0.1 and n is 0.9, and the melamine-containing copolyimide of Formula (III) has a number average molecular weight (Mₙ) of about 18 to about 26 kilograms per mole (kg/mol).

In some embodiments, m is 0.1 and n is 0.9, and the melamine-containing copolyimide of Formula (III) has a weight average molecular weight (M_{w}) of about 31 to about 41 kg/mol.

In some embodiments, m is 0.1 and n is 0.9, and the melamine-containing copolyimide of Formula (III) has a polydispersity index (PDI) of about 1.5 to about 1.9.

In some embodiments, the melamine-containing copolyimide has a Formula (IV):

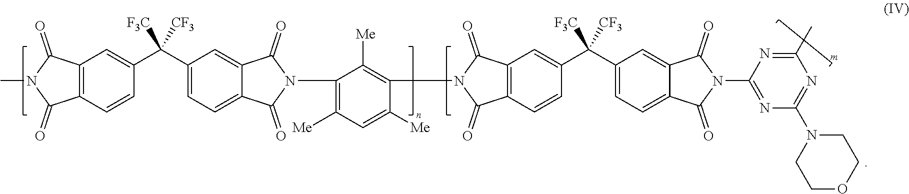

In some embodiments, m is 0.1 and n is 0.9, and the melamine-containing copolyimide of Formula (IV) has a Mₙ of about 10 to about 18 kg/mol.

In some embodiments, m is 0.1 and n is 0.9, and the melamine-containing copolyimide of Formula (IV) has a M_{w} of about 23 to about 33 kg/mol.

In some embodiments, m is 0.1 and n is 0.9, and the melamine-containing copolyimide of Formula (IV) has a PDI of about 1.7 to about 2.1.

In an exemplary embodiment, a membrane comprising the melamine-containing copolyimide.

In some embodiments, the membrane contains at least about 80 wt. % of the melamine-containing copolyimide.

In an exemplary embodiment, a method of separating carbon dioxide (CO₂) from a CO₂-containing gas mixture includes passing the CO₂-containing gas mixture through a melamine-containing copolyimide membrane containing the melamine-containing copolyimide to form a purified gas by absorbing the CO₂ and allowing the CO₂-containing gas mixture to pass through the melamine-containing copolyimide membrane.

In some embodiments, the CO₂-containing gas mixture further contains one or more components selected from the group consisting of methane (CH₄), ethane (C₂H₆), propane (C₃H₈), butane (C₄H₁₀), nitrogen (N₂), hydrogen sulfide (H₂S), and water (H₂O) vapor.

In some embodiments, the CO₂-containing gas mixture contains CO₂ and CH₄.

In some embodiments, the CO₂-containing gas mixture is contacted with the melamine-containing copolyimide membrane at a temperature of about 20 to about 30° C. and a pressure of about 100 to about 800 pounds per square inch (psi).

In some embodiments, the CO₂-containing gas mixture contains CO₂ and CH₄, and the method has a CO₂/CH₄ selectivity of about 38.8 at 25° C. and 100 psi.

In some embodiments, the method further includes preparing the melamine-containing copolyimide membrane by mixing the melamine-containing copolyimide in a solvent to form a mixture; casting the mixture into a mold to form a sample; and drying the sample at a temperature of about 100 to about 180° C.

In some embodiments, the solvent is selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, and mixtures thereof.

In some embodiments, the method further includes preparing the melamine-containing copolyimide by mixing monomers of 4,4′-(hexafluoroisopropylidene)diphthalic anhydride (6FDA), an aromatic diamine, a melamine compound, and the solvent to form a first reaction mixture containing one or more polyamic acids; mixing an amine base and an acetic anhydride to form a second mixture; mixing the first reaction mixture and the second mixture, thereby reacting the one or more polyamic acids with the acetic anhydride to form a crude product mixture containing the melamine-containing copolyimide; adding the crude product mixture into water to precipitate the melamine-containing copolyimide from the crude product mixture; and removing the melamine-containing copolyimide from the crude product mixture, washing with water, and drying at a temperature of about 110 to about 200° C.

In some embodiments, the aromatic diamine is 2,4,6-trimethyl-m-phenylenediamine, and the melamine compound has a Formula (V)

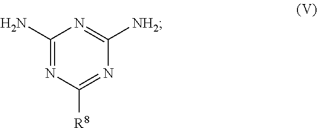

wherein R⁸ is selected from the group consisting of

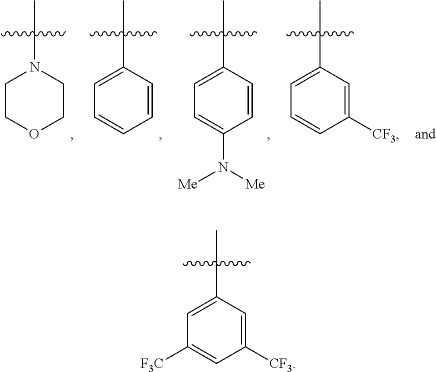

### BRIEF DESCRIPTION OF THE DRAWINGS

FIG. 1 is a schematic diagram depicting CO₂ interactions with traditional melamine-containing materials (left) and with the polyimides of the present disclosure (right), according to certain embodiments of the present disclosure.

FIG. 2 is the ¹H NMR spectrum of 4,4′-(hexafluoroisopropylidene) diphthalic anhydride (6FDA-DAM)-based phenylmelamine copolyimide (6FDA-DAM/MEL-I, P1), according to certain embodiments of the present disclosure.

FIG. 3 is the ¹⁹F NMR spectrum of 6FDA-DAM/MEL-I (P1), according to certain embodiments of the present disclosure.

FIG. 4 is the ¹H NMR spectrum of 6-morpholino-1,3,5-triazine-2,4-diamine (MEL-II), according to certain embodiments of the present disclosure.

FIG. 5 is the ¹H NMR spectrum of 6FDA-DAM-based heterocyclic melamine copolyimide (6FDA-DAM/MEL-II, P2), according to certain embodiments of the present disclosure.

FIG. 6 is the ¹⁹F NMR spectrum of 6FDA-DAM/MEL-II (P2), according to certain embodiments of the present disclosure.

FIG. 7 is a schematic diagram depicting Gel Permeation Chromatography (GPC) trace of 6FDA-DAM/MEL-I (P1), according to certain embodiments of the present disclosure.

FIG. 8 is a schematic diagram depicting Gel Permeation Chromatography (GPC) trace of 6FDA-DAM/MEL-II (P2), according to certain embodiments of the present disclosure.

FIG. 9 is the Fourier transform infrared (FTIR) spectra of 6FDA-DAM/MEL-I (P1) and 6FDA-DAM/MEL-II (P2), according to certain embodiments of the present disclosure.

FIG. 10 shows the differential scanning calorimetric (DSC) analysis of 6FDA-DAM/MEL-I (P1) and 6FDA-DAM/MEL-II (P2), according to certain embodiments of the present disclosure.

FIG. 11 shows the thermogravimetric analysis (TGA) of 6FDA-DAM/MEL-I (P1) and 6FDA-DAM/MEL-II (P2), according to certain embodiments of the present disclosure.

FIG. 12 is a schematic diagram of a constant-volume, variable pressure permeation apparatus used for measuring single gas and mixed gas permeation properties, according to certain embodiments of the present disclosure.

FIG. 13 shows the membrane permeability-selectivity “trade-off” curve (CO₂/CH₄ vs. CO₂ permeability) of various copolyimides in pure gas at 25° C. and 100 psi, according to certain embodiments of the present disclosure.

FIG. 14 shows the membrane permeability-selectivity “trade-off” curve (CO₂/CH₄ vs. CO₂ permeability) of various copolyimides under binary gas mixture (20% CO₂/80% CH₄) at 25° C. and 800 psi, according to certain embodiments of the present disclosure.

FIG. 15 shows the mixed gas separation results of 6FDA-DAM/MEL-I (P1) and 6FDA-DAM/MEL-II (P2) under a pressure of 200 to 800 psi at 25° C., according to certain embodiments of the present disclosure.

FIG. 16 shows the sweet mixed gas separation results of 6FDA-DAM/MEL-II (P2) under a pressure of 200 to 800 psi at 25° C., according to certain embodiments of the present disclosure.

FIG. 17 shows pure and mixed gas (CO₂/CH₄=20/80) sorption selectivity results of 6FDA-DAM/MEL-I (P1) at 1 atm and 25° C., according to certain embodiments of the present disclosure.

### DETAILED DESCRIPTION

Provided in the present disclosure are polyimide membranes prepared from polyimides containing melamine-based diamine moieties. The membranes of the present disclosure can be used for sour natural gas purification applications. Also provided in this disclosure are methods for preparing polyimide structures containing melamine-based diamine moieties, and methods for preparing membranes containing the polyimide structures. The incorporation of melamine-based diamine moieties into polyimides results in structures with quadripolar alignment to assist CO₂ binding, which can simultaneously improve the diffusivity of gas molecules through the polymeric matrix of membranes containing such moieties.

In view of the foregoing, one objective of the present disclosure is to provide a melamine-containing copolyimide. A second objective of the present disclosure is to provide a membrane containing the melamine-containing copolyimide. A third objective of the present disclosure is to provide a method of separating carbon dioxide (CO₂) from a CO₂-containing gas mixture. A fourth objective of the present disclosure is to provide a method of preparing the melamine-containing copolyimide membrane and the melamine-containing copolyimide.

### Definitions

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “room temperature” and “ambient temperature” refer to a temperature in a range of 25 degrees Celsius (° C.)±3° C.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “volume percent” (vol %) refers to a volume fraction or a volume ratio of a substance to the total volume of the mixture or composition.

As used herein, the term “substantially” refers to a majority of, or mostly, as in at least about 50%, such as about 60%, about 70%, about 80%, about 90%, about 95%, about 96%, about 97%, about 98%, about 99%, about 99.5%, about 99.9%, about 99.99%, or at least about 99.999% or more.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms “sour” or “sour gas” mean that the gas stream contains hydrogen sulfide (H₂S).

As used in the present disclosure, the term “monomer unit,” used in reference to a polymer, refers to a monomer, or residue of a monomer, that has been incorporated into at least a portion of the polymer.

As used in the present disclosure, the term “polymerization product,” used in reference to one or more monomers, refers to a polymer that can be formed by a chemical reaction of the one or more monomers. For example, a “polymerization product” of acrylic acid is a polymer containing acrylic acid monomer units.

As used in the present disclosure, the term “Cₙ₋ₘ alkyl” refers to any linear or branched saturated hydrocarbon group having n to m carbons. Alkyl groups include, but are not limited to, methyl, ethyl, propyl such as propan-1-yl, propan-2-yl (iso-propyl), butyl such as butan-1-yl, butan-2-yl (sec-butyl), 2-methyl-propan-1-yl (iso-butyl), 2-methyl-propan-2-yl (t-butyl), pentyl, hexyl, octyl, dectyl, and the like. As used in the present disclosure, the term “alkylene” refers to a bivalent alkyl.

As used in the present disclosure, the term “Cₙ₋ₘ haloalkyl” refers to the alkyl group defined above replaced by one or more halogens.

As used in the present disclosure, the term “Cₙ₋ₘ cycloalkyl” refers to a monocyclic or polycyclic non-aromatic radical, in which each of the ring-forming atoms (i.e., skeletal atoms) is a carbon atom. In one embodiment, the cycloalkyl group is saturated or partially unsaturated. In another embodiment, the cycloalkyl group is fused to an aromatic ring. Cycloalkyl groups include groups having 3 to 20 ring atoms. Illustrative examples of cycloalkyl groups include, but are not limited to, the following moieties:

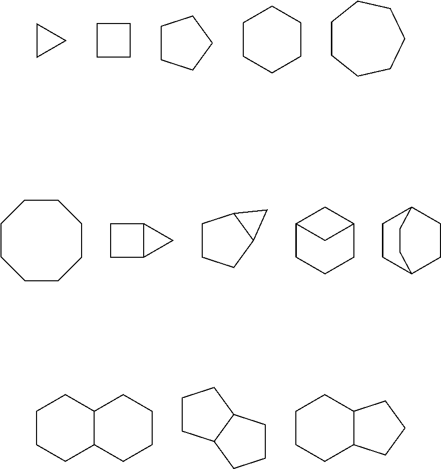

Monocyclic cycloalkyls include, but are not limited to, cyclopropyl, cyclobutyl, cyclopentyl, cyclohexyl, cycloheptyl, and cyclooctyl. Dicyclic cycloalkyls include, but are not limited to, tetrahydronaphthyl, indanyl, and tetrahydropentalene. Polycyclic cycloalkyls include adamantine and norbornane. The term “cycloalkyl” includes “unsaturated non-aromatic carbocyclyl” and “non-aromatic unsaturated carbocyclyl” groups, which refer to a non-aromatic carbocycle as defined herein, containing at least one carbon double bond or one carbon triple bond.

As used herein, the term “heterocycloalkyl,” “heterocyclyl,” or “heterocyclylic” refers to an aliphatic heterocyclyl containing one to four ring heteroatoms, each selected from O, S, and N. In one embodiment, each heterocycloalkyl group has from 4 to 20 atoms in their ring system, provided that the ring of that group does not contain two adjacent O or S atoms. In another embodiment, the heterocycloalkyl group is fused to an aromatic ring. In one embodiment, the nitrogen and sulfur heteroatoms can be optionally oxidized, and the nitrogen atom can be optionally quaternized. The heterocyclic system can be attached, unless otherwise noted, at any heteroatom or carbon atom that provides a stable structure. A heterocycle can be aromatic or non-aromatic in nature. In one embodiment, the heterocycle is a heteroaryl. An example of a 3-membered heterocycloalkyl group includes, and is not limited to, aziridine. Examples of 4-membered heterocycloalkyl groups include, and are not limited to, azetidine and a beta lactam. Examples of 5-membered heterocycloalkyl groups include, and are not limited to, pyrrolidine, oxazolidine, and thiazolidinedione. Examples of 6-membered heterocycloalkyl groups include, and are not limited to, piperidine, morpholine, and piperazine.

Examples of non-aromatic heterocycles include, but are not limited to, monocyclic groups such as aziridine, oxirane, thiirane, azetidine, oxetane, thiethane, pyrrolidine, pyrroline, pyrazolidine, imidazoline, dioxolane, sulfolane, 2,3-dihydrofuran, 2,5-dihydrofuran, tetrahydrofuran, thiophane, piperidine, 1,2,3,6-tetrahydropyridine, 1,4-dihydropyridine, piperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin, and hexamethylene oxide.

As used herein, the term “aromatic” refers to a carbocycle or heterocycle with one or more polyunsaturated rings and having an aromatic character, that is, having delocalized (4n 2) p (pi) electrons, where n is a whole number.

As used herein, the term “aryl,” used alone or in combination with other terms, means, unless otherwise noted, a carbocyclic aromatic system containing one or more rings (typically one, two or three rings), wherein said rings may be pendant together, such as a biphenyl, or they may be fused, such as naphthalene. Examples of aryl groups include, but are not limited to, phenyl, anthracyl, and naphthyl.

As used herein, the term “heteroaryl” and “heteroaromatic” refer to a heterocycle having aromatic character. A polycyclic heteroaryl can include one or more rings that are partially saturated. Examples of heteroaryl groups also include, but are not limited to, pyridyl, pyrazinyl, pyrimidinyl (particularly 2- and 4-pyrimidinyl), pyridazinyl, thienyl, furyl, pyrrolyl (particularly 2-pyrrolyl), imidazolyl, thiazolyl, oxazolyl, pyrazolyl (particularly 3- and 5-pyrazolyl), isothiazolyl, 1,2,3-triazolyl, 1,2,4-triazolyl, 1,3,4-triazolyl, tetrazolyl, 1,2,3-thiadiazolyl, 1,2,3-oxadiazolyl, 1,3, 4-thiadiazolyl and 1,3,4-oxadiazolyl.

As used in the present disclosure, the term “polycyclic aromatic hydrocarbon” refers to any multiple-condensed ring system of two or more fused, all-carbon aromatic rings. Polycyclic aromatic hydrocarbons include, but are not limited to, naphthalene, anthracene, triphenylene, pyrene, perylene, and the like. In some embodiments, the polycyclic aromatic hydrocarbon includes polycyclic heterocycles and heteroaryls. Examples of polycyclic heterocycles and heteroaryls include indolyl (particularly 3-, 4-, 5-, 6-, and 7-indolyl), indolinyl, quinolyl, tetrahydroquinolyl, isoquinolyl (particularly 1- and 5-isoquinolyl), 1,2,3, 4-tetrahydroisoquinolyl, cinnolinyl, quinoxalinyl (particularly 2- and 5-quinoxalinyl), quinazolinyl, phthalazinyl, 1,8-naphthyridinyl, 1,4-benzodioxanyl, coumarin, dihydrocoumarin, 1,5-naphthyridinyl, benzofuryl (particularly 3-, 4-, 5-, 6- and 7-benzofuryl), 2,3-dihydrobenzofuryl, 1,2-benzisoxazolyl, benzothienyl (particularly 3-, 4-, 5-, 6-, and 7-benzothienyl), benzoxazolyl, benzothiazolyl (particularly 2-benzothiazolyl and 5-benzothiazolyl), purinyl, benzimidazolyl (particularly 2-benzimidazolyl), benzotriazolyl, thioxanthinyl, carbazolyl, carbolinyl, acridinyl, pyrrolizidinyl, and quinolizidinyl.

As used in the present disclosure, the term “halo” refers to —F, —Cl, —Br, or —I.

As used in the present disclosure, the term “hydroxyl” refers to —OH.

As used in the present disclosure, the term “amino” refers to —NH₂.

As used in the present disclosure, the term “thiol” refers to —SH.

As used in the present disclosure, the term “carboxyl” refers to —C(O)OH.

As used in the present disclosure, the term “azido” refers to —N₃.

Where a variable of the present disclosure defines a group having more than one substituent (for example, group A of Formula (I)) and the Markush group definition for that variable lists, for example, a polycyclic aromatic hydrocarbon, then it is understood that the polycyclic aromatic hydrocarbon represents a substituent having the necessary valency.

### Polymers

The interaction of melamine (MEL) and its derivatives with CO₂ is attributed to the presence of nitrogen-rich functional groups within the melamine structure, which can form bonds or weak interactions with CO₂ molecules. These interactions make MEL and its derivatives suitable for the development of CO₂-containing gas separation membranes. The present disclosure provides copolyimide membranes based on 4,4′-(hexafluoroisopropylidene) diphthalic anhydride (6FDA)-2,4,6-trimethyl-1,3-diaminobenzene-(DAM) and MEL. In some embodiments, the membranes are synthesized using functionalized melamine-based diamines as co-monomers incorporated into the polymer backbone, such as shown in Scheme 1. The 6FDA-DAM/MEL copolyimides of the present disclosure demonstrate improved physical and chemical stability, film-forming capabilities, and synthetic versatility as compared to 6FDA based copolyimides without melamine-based diamines. In some embodiments, the copolyimides are used to produce robust membrane films via a solution-casting method. When compared to a 6FDA-DAM membrane that does not contain MEL. In one embodiment, the 6FDA-DAM/MEL copolyimide membranes exhibits more than an 80% increase in CO₂/CH₄ selectivity. Without wishing to be bound by any particular theory, it is believed that this improvement in selectivity can be attributed to the enhanced CO₂ affinity of the incorporated melamine comonomers. By refining permeation properties and separation characteristics, melamine-containing 6FDA-based copolyimide membranes with various melamine motifs can advance CO₂-selective separation and contribute to the effective purification of industrial sour gas.

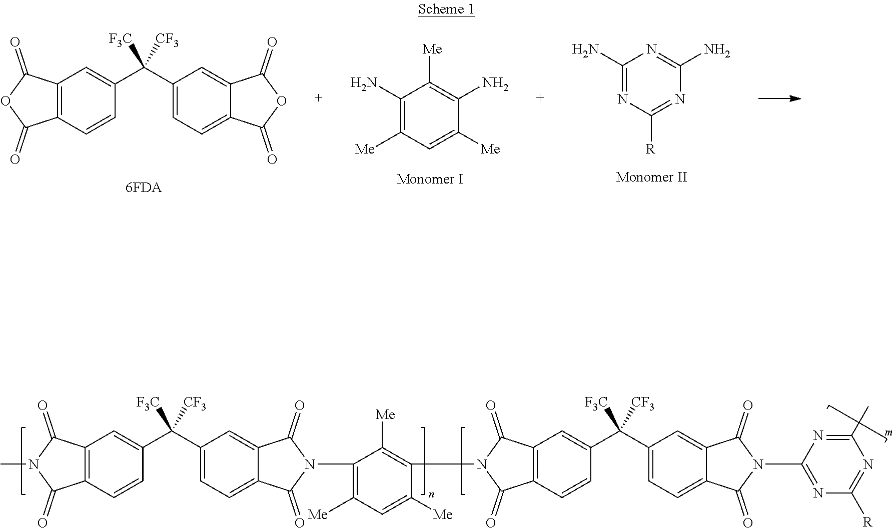

The polymers of the present disclosure contain functionalized melamine (MEL) comonomers. In some embodiments, the melamine comonomers are prepared by the nucleophilic substitution of 2-chloro-4.6-diamino-1,3,5-triazine with a heterocycloalkyl group (Het), as depicted in Scheme 2. In some embodiments, the heterocycloalkyl compound has from 4 to 20 atoms in their Het ring system, provided that the ring of that group does not contain two adjacent O or S atoms. In another embodiment, the heterocycloalkyl compound is fused to an aromatic ring. In one embodiment, the nitrogen heteroatom present in the heterocycloalkyl compound can be optionally oxidized or optionally quaternized.

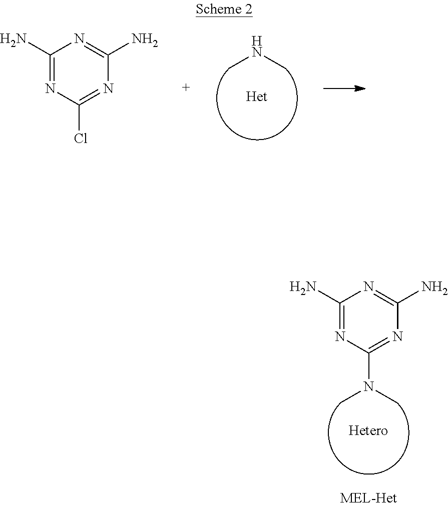

Exemplary MEL comonomers that can be prepared by nucleophilic substitution and used in the polymers and membranes of the present disclosure include, but are not limited to:

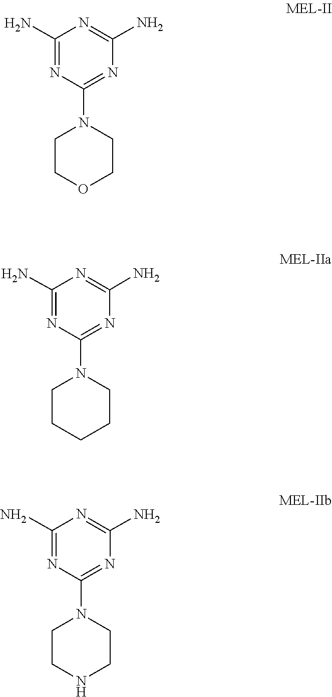 [SMILES: Nc1nc(N)nc(N2CCOCC2)n1 ; Nc1nc(N)nc(N2CCCCC2)n1 ; Nc1nc(N)nc(N2CCNCC2)n1]

In some embodiments, the melamine comonomers are prepared by the condensation reaction of cyanoguanidines with aryl nitriles, as depicted in Scheme 3.

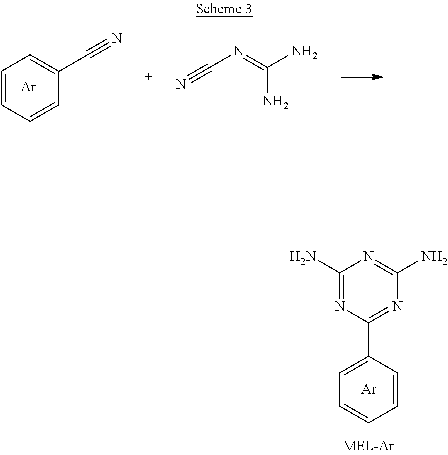

Exemplary MEL-Ar comonomers that can be prepared and used in the polymers and membranes of the present disclosure include, but are not limited to:

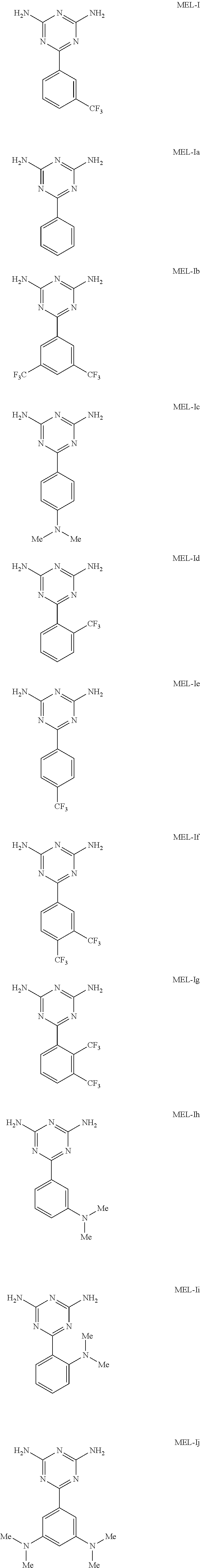

In some embodiments, other types of difunctional melamine alternatives can be prepared and used as MEL comonomers for the polymerization including heterocycles with one, two, or three nitrogen atoms. Exemplary difunctional melamine alternatives that can be used in the polymers and membranes of the present disclosure include, but are not limited to:

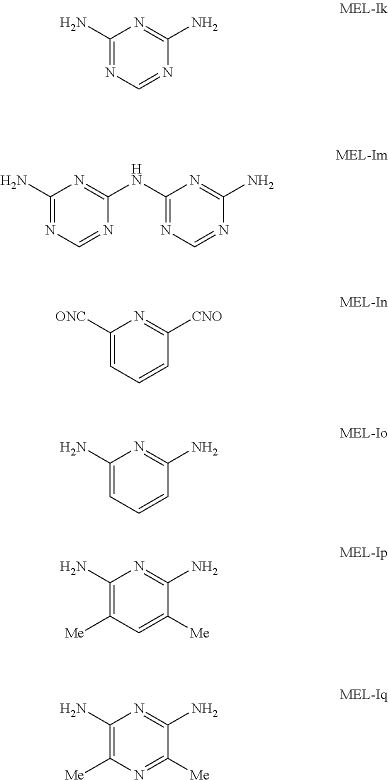

The prepared MEL comonomers can be reacted with a variety of dianhydride monomers in the presence of a variety of aromatic diamine monomers to afford copolyimides (Scheme 4) via condensation polymerization and chemical imidization, where Ar₁ of monomer I represents the various aromatic moieties that can be used in the preparation of the melamine-containing copolyimides of the present disclosure.

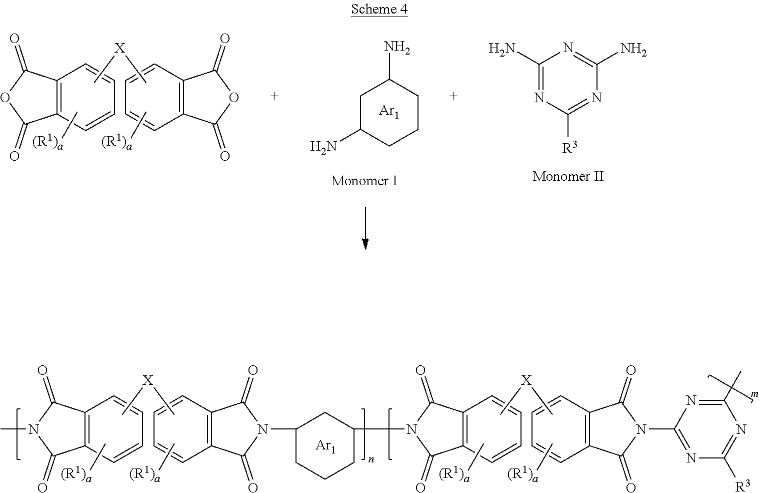

In some embodiments, X is independently selected from a bond, —O—, —C(O)—, —O-phenyl-C₁₋₄ alkylene-phenyl-O—, and C₁₋₄ alkylene optionally substituted with one, two, three, or four independently selected R⁵. In some embodiments, R¹ is independently selected from halo, C₁₋₄ alkyl, and C₁₋₄ haloalkyl. In some embodiments, R³ is selected from H, —OH, halo, C₁₋₆ alkyl, C₁₋₆ haloalkyl, phenyl, C₁₋₄ alkyl-phenyl, C₃₋₂₀ cycloalkyl, C₆₋₂₀ aryl, C₆₋₂₀ heteroaryl, C₆₋₂₀ heterocycloalkyl, and —NR^{a}R^{b}, wherein R^{a} and R^{b} are each independently selected from H and C₁₋₆ alkyl, wherein the C₁₋₄ alkyl-phenyl, C₃₋₂₀ cycloalkyl, C₆₋₂₀ aryl, C₆₋₂₀ heteroaryl, and C₆₋₂₀ heterocycloalkyl are each optionally substituted with one, two, three, or four independently selected R⁶. In some embodiments, each R⁵ and R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃. In some embodiments, a and b are each independently 0, 1, 2, or 3. In some embodiments, m+n=1.

The copolymerization aims to combine the gas permeation properties of two separate homopolymers into one copolymer structure. The copolyimides can be used to prepare polymeric membranes with improved sweet and/or sour mixed-gas separation properties for natural gas purification applications. In some embodiments, the diamine monomer I in Scheme 4 is chosen to complement the properties provided by the MEL comonomers (monomer II) in Scheme 4 to either improve the permeability or selectivity of the copolyimide membrane.

Exemplary dianhydride monomers that can be used in the polymers and membranes of the present application include, but are not limited to:

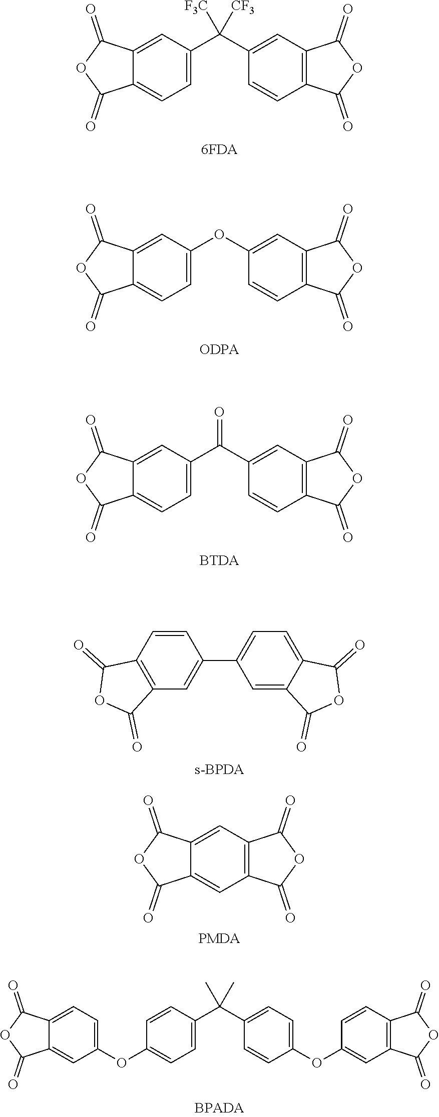

The aromatic diamine monomer I in Scheme 4 used in the preparation of the copolyimides of the present disclosure can be used to provide polymer segments that can tailor the properties of the targeted polymeric materials. Exemplary diamine monomers that can be used in the polymers and membranes of the present application include, but are not limited to:

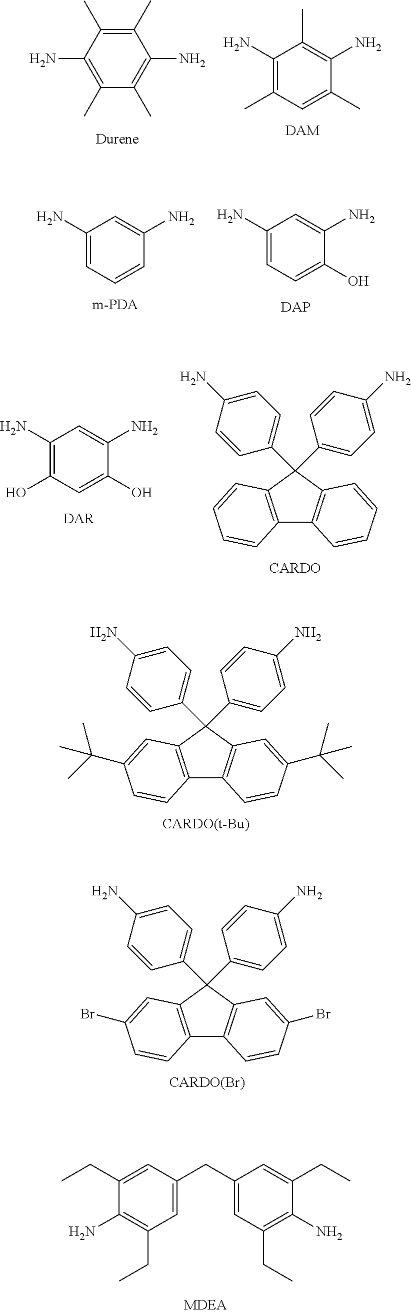

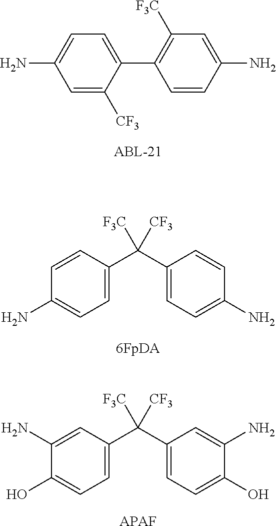

Thus, provided in the present disclosure are polymers that contain a structural repeat unit of Formula (I):
a structural repeat unit of Formula (I):

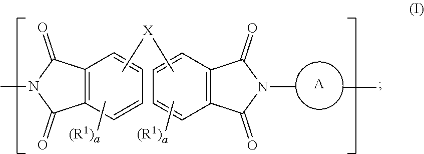

and
a structural repeat unit of Formula (II):

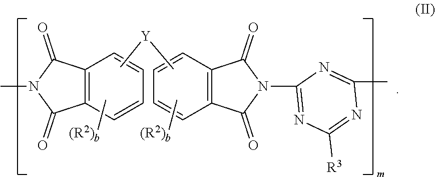

wherein:
Ring moiety A is selected from phenylene, biphenylene, terphenylene, and polycyclic aromatic hydrocarbon, wherein the phenylene, biphenylene, terphenylene, and polycyclic aromatic hydrocarbon are each optionally substituted with one, two, three, or four independently selected R⁴;
X and Y are each independently selected from a bond, —O—, —C(O)—, —O-phenyl-C₁₋₄ alkylene-phenyl-O—, and C₁₋₄ alkylene optionally substituted with one, two, three, or four independently selected R⁵;
each R¹ and R² is independently selected from halo,C₁₋₄ alkyl, and C₁₋₄ haloalkyl;
R³ is selected from H, —OH, halo, C₁₋₆ alkyl, C₁₋₆ haloalkyl, phenyl, C₁₋₄ alkyl-phenyl, C₃₋₂₀ cycloalkyl, C₆₋₂₀ aryl, C₆₋₂₀ heteroaryl, C₆₋₂₀ heterocycloalkyl, and —NR^{a}R^{b}, wherein R^{a} and R^{b} are each independently selected from H and C₁₋₆ alkyl, wherein the C₁₋₄ alkyl-phenyl, C₃₋₂₀ cycloalkyl, C₆₋₂₀ aryl, C₆₋₂₀ heteroaryl, and C₆₋₂₀ heterocycloalkyl are each optionally substituted with one, two, three, or four independently selected R⁶;
each R⁴, R⁵, and R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃;
a and b are each independently 0, 1, 2, or 3; and
m+n=1.

In some embodiments, Ring moiety A is phenylene optionally substituted with one, two, three, or four R⁴.

In some embodiments, each R⁴ is independently C₁₋₄ alkyl.

In some embodiments, X and Y are each methyl, each optionally substituted with one or two R⁵.

In some embodiments, each R⁵ is independently C₁ alkyl optionally substituted with one, two, or three R⁷, and each R⁷ is independently halo.

In some embodiments, X and Y are each methyl. In some embodiments, each methyl is substituted with two —CF₃.

In some embodiments, R³ is selected from H, —OH, halo, C₁₋₄ alkyl, phenyl, C₁₋₄ alkyl-phenyl, and C₆₋₂₀ heterocycloalkyl, wherein the C₁₋₄ alkyl-phenyl and C₆₋₂₀ heterocycloalkyl are each substituted with one, two, three, or four independently selected R⁶.

In some embodiments, a and b are each independently 0 or 1.

In some embodiments, m is between 0.05 to 0.2, such as 0.08 to 0.18, 0.10 to 0.16, 0.12 to 0.14, or about 0.13. In some embodiments, n is between 0.8 to 0.95, such as 0.82 to 0.93, 0.84 to 0.91, 0.86 to 0.89, or 0.88.

In some embodiments, the melamine-containing copolyimide has a number-average molecular weight of about 1,000 g/mol to about 1,000,000 g/mol, such as about 1,000 g/mol to about 900,000 g/mol, about 10,000 g/mol to about 800,000 g/mol, about 50,000 g/mol to about 700,000 g/mol, about 100,000 g/mol to about 600,000 g/mol, about 200,000 g/mol to about 500,000 g/mol, about 300,000 g/mol, or about 1,000 g/mol, about 5,000 g/mol, about 10,000 g/mol, about 25,000 g/mol, about 50,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, about 500,000 g/mol, about 550,000 g/mol, about 600,000 g/mol, about 650,000 g/mol, about 700,000 g/mol, about 750,000 g/mol, about 800,000 g/mol, about 850,000 g/mol, about 900,000 g/mol, about 950,000 g/mol, or about 1,000,000 g/mol.

The polymers of the present disclosure can be prepared according to any suitable method. For example, polymers including a structural repeat unit of Formula (I) and a structural repeat unit of Formula (II) can be prepared by polycondensation of a dianhydride monomer, a Mel monomer, and an aromatic diamino monomer. In some embodiments, the polymer includes the polymerization product of a diphthalic anhydride monomer (for example, 5,5′-(perfluoropropane-2,2-diyl)bis(isobenzofuran-1,3-dione), a monomer of Mel I or Mel II, and an aromatic diamino monomer (for example, 2,4,6-trimethylbenzene-1,3-diamine (DAM)).

The synthetic methodology described in the present disclosure allows for the preparation of a large variety of melamine-containing copolyimide, including, but not limited to, homopolymers, random copolymers, block copolymers, terpolymers, alternating copolymers, and so on.

### Formula (I)

In some embodiments, A is phenylene, biphenylene, terphenylene, naphthalenylene, or anthracenylene. In some embodiments, A is phenylene. In some embodiments, A is optionally substituted with one, two, three, or four R⁴. In some embodiments, A is substituted with two or three R⁴. In some embodiments, A is phenylene substituted with three R⁴. In some embodiments, at least one R⁴ is independently C₁₋₄ alkyl. In some embodiments, each R⁴ is independently C₁₋₄ alkyl. In some embodiments, A has the structure:

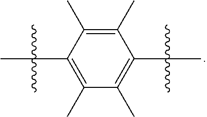 [SMILES: *c1c(C)c(C)c(*)c(C)c1C]

In some embodiments, A has the structure:

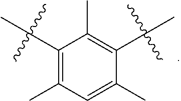 [SMILES: *c1c(C)cc(C)c(*)c1C]

In some embodiments, X is selected from a bond, —O—, —C(O)—, —O-phenyl-C₁₋₄ alkylene-phenyl-O—, and C₁₋₄ alkylene optionally substituted with one, two, three, or four independently selected R⁵.

In some embodiments, X is a bond.

In some embodiments, X is —O—.

In some embodiments, X is —C(O)—.

In some embodiments, X is —O-phenyl-C₁₋₄ alkylene-phenyl-O—. In some embodiments, X is —O-phenyl-C₁₋₃ alkylene-phenyl-O In some embodiments, X is —O-phenyl-C₁₋₂ alkylene-phenyl-O. In some embodiments, X is —O-phenyl-methyl-phenyl-O.

In some embodiments, X is C₁₋₄ alkylene optionally substituted with one, two, three, or four independently selected R⁵. In some embodiments, X is C₁₋₃ alkylene optionally substituted with one, two, three, or four independently selected R⁵. In some embodiments, X is C₁₋₂ alkylene optionally substituted with one, two, three, or four independently selected R⁵. In some embodiments, X is C₁ alkylene optionally substituted with one, two, three, or four independently selected R⁵.

In some embodiments, X is C₁ alkylene. In some embodiments, X is optionally substituted with one or two R⁵. For example, in some embodiments, X is substituted with one or two R⁵. In some embodiments of Formula (I), one or more R⁵ are each independently C₁ alkyl optionally substituted with one, two, or three halo. In some embodiments of Formula (I), each R⁵ is independently C₁ alkyl optionally substituted with one, two, or three halo. In some embodiments of Formula (I), each R⁵ is independently C₁ alkyl substituted with three halo. In some embodiments, one or more halo are —F. In some embodiments each halo is —F.

In some embodiments, each a is independently 0 or 1. In some embodiments, each a is 0.

In some embodiments, the structural repeat unit of Formula (I) is a structural repeat unit of Formula (I-A):

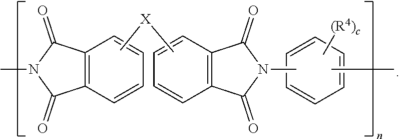

In some embodiments, c is 0, 1, 2, 3, or 4. In some embodiments, c is 0. In some embodiments, c is 1. In some embodiments, c is 2. In some embodiments, c is 3. In some embodiments, c is 4. In certain embodiments of Formula (I-A), each R⁴ is independently selected from hydrogen, halo, —OH, —NH₂, —SH, —C(O)OH, —N₃, and C₁₋₄ alkyl optionally substituted with one, two, three, or four independently selected R⁷. In some embodiments, each R⁷ is independently selected from hydrogen, halo, —OH, —NH₂, —SH, —C(O)OH, and —N₃.

In certain embodiments of Formula (I-A), X is the same as Y of Formula (II) or Formula (II-A) of the present disclosure. In some embodiments of Formula (I-A), X is methyl substituted with one or two R⁵. In some embodiments, Formula (I-A) includes three or four R⁵ groups. In certain embodiments of Formula (I-A), each R⁵ is independently unsubstituted C₁₋₄ alkyl, and each R⁵ is independently C₁₋₄ alkyl substituted with three halo.

In some embodiments, the structural repeat unit of Formula (I) is a structural repeat unit of Formula (I-B):

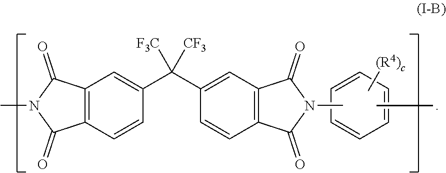

In some embodiments, c is 0, 1, 2, 3, or 4. In some embodiments, c is 0. In some embodiments, c is 1. In some embodiments, c is 2. In some embodiments, c is 3. In some embodiments, c is 4. In certain embodiments of Formula (I-B), each R⁴ is independently unsubstituted C₁₋₄ alkyl. In certain such embodiments, each R⁴ is unsubstituted C₁ alkyl. In some embodiments, Formula (I-B) includes three or four R⁴ groups.

### Formula (II)

In some embodiments, Y is selected from a bond, —O—, —C(O)—, —O-phenyl-C₁₋₄ alkylene-phenyl-O—, and C₁₋₄ alkylene optionally substituted with one, two, three, or four independently selected R⁵.

In some embodiments, Y is a bond.

In some embodiments, Y is —O—.

In some embodiments, Y is —C(O)—.

In some embodiments, Y is —O-phenyl-C₁₋₄ alkylene-phenyl-O—. In some embodiments, Y is —O-phenyl-C₁₋₃ alkylene-phenyl-O—. In some embodiments, Y is —O-phenyl-C₁₋₂ alkylene-phenyl-O—. In some embodiments, Y is —O-phenyl-methyl-phenyl-O—.

In some embodiments, Y is C₁₋₄ alkylene optionally substituted with one, two, three, or four independently selected R⁵. In some embodiments, Y is C₁₋₃ alkylene optionally substituted with one, two, three, or four independently selected R⁵. In some embodiments, Y is C₁₋₂ alkylene optionally substituted with one, two, three, or four independently selected R⁵. In some embodiments, Y is methyl optionally substituted with one, two, three, or four independently selected R⁵.

In some embodiments, each R⁵ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen halo, —OH, —NH₂, —SH, —C(O)OH, and —N₃. In some embodiments, each R⁶ is independently selected from C₁₋₄ alkyl optionally substituted with one, two, three, or four independently selected R⁷. In some embodiments, R⁷ is halo. In some embodiments, Y is C₁ methyl substituted with two —CF₃. In some embodiments, Y is —O-phenyl-methyl-phenyl-O—, where the methyl is substituted with two —CH₃.

In some embodiments, Y is methyl. In some embodiments, Y is optionally substituted with one or two R⁵. For example, in some embodiments, Y is substituted with one or two R⁵. In some embodiments of Formula (II), one or two R⁵ are each independently C₁ alkyl optionally substituted with one, two, or three halo. In some embodiments of Formula (II), each R⁵ is independently C₁ alkyl optionally substituted with one, two, or three halo. In some embodiments of Formula (II), each R⁵ is independently C₁ alkyl substituted with three halo. In some embodiments, one or more halo are —F. In some embodiments each halo is —F.

In some embodiments, R³ is selected from H, —OH, halo, C₁₋₆ alkyl, C₁₋₆ haloalkyl, phenyl, C₁₋₄ alkyl-phenyl optionally substituted with one, two, three, or four independently selected R⁶, C₃₋₂₀ cycloalkyl optionally substituted with one, two, three, or four independently selected R⁶, C₆₋₂₀ aryl substituted with one, two, three, or four independently selected R⁶, C₆₋₂₀ heteroaryl with one, two, three, or four independently selected R⁶, C₆₋₂₀ heterocycloalkyl with one, two, three, or four independently selected R⁶, and —NR^{a}R^{b}, wherein R^{a} and R^{b} are each independently selected from H and C₁₋₆ alkyl. In some embodiments, each R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃.

In some embodiments, each b is independently 0 or 1. In some embodiments, each b is 0.

In some embodiments, the structural repeat unit of Formula (II) is a structural repeat unit of Formula (II-A):

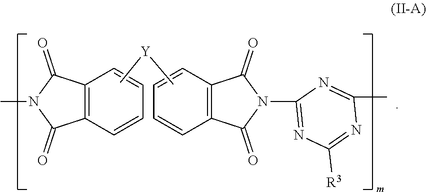

In certain embodiments of Formula (II-A), Y is the same as X of Formula (I) or Formula (I-A) of the present disclosure. In some embodiments of Formula (II-A), Y is methyl substituted with one or two R⁵. In some embodiments, Formula (II-A) includes three or four R⁵ groups. In certain embodiments of Formula (II-A), each R⁵ is independently unsubstituted C₁₋₄ alkyl, and each R⁵ is independently C₁₋₄ alkyl substituted with three halo.

In some embodiments of Formula (II-A), R³ is selected from:

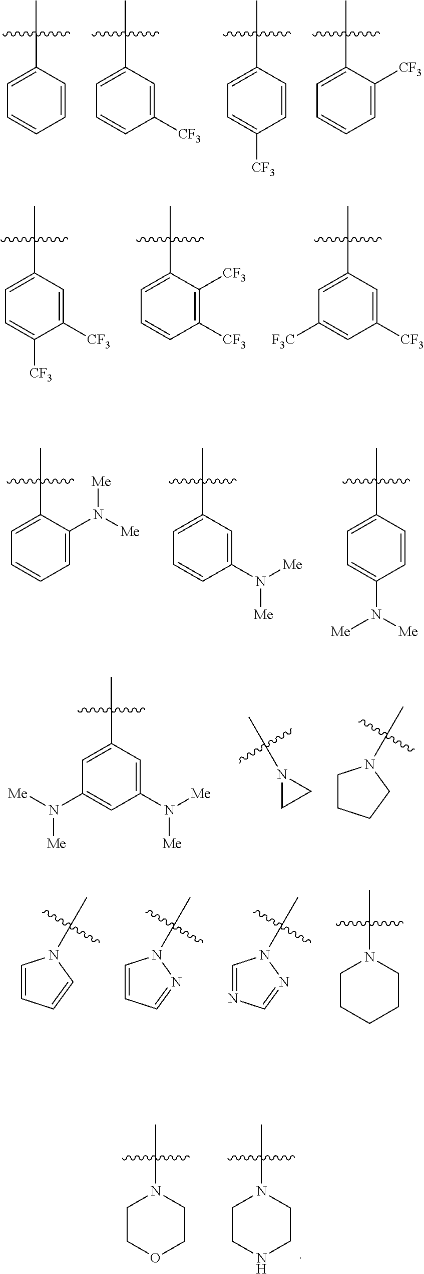

In some embodiments, the structural repeat unit of Formula (II) is a structural repeat unit of Formula (II-B)

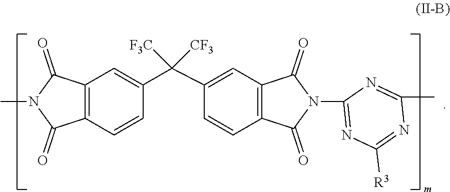

In some embodiments of Formula (II-B), R³ is selected from:

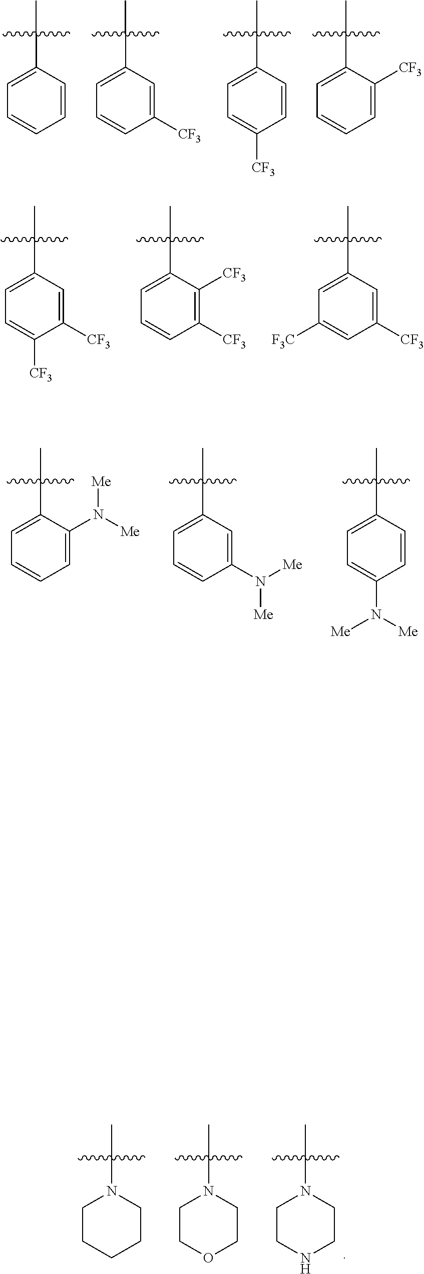

In some embodiments, the melamine-containing copolyimide has a Formula (III):

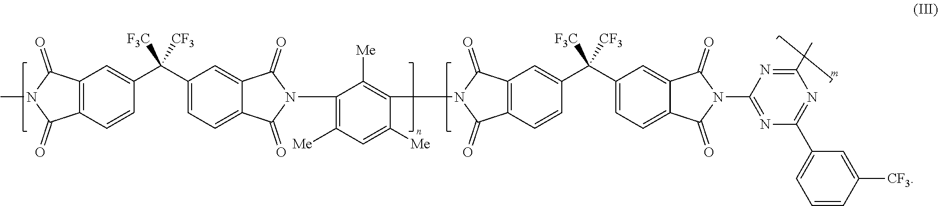

In certain embodiments of Formula (III), m is 0.1 and n is 0.9. In some embodiments, the melamine-containing copolyimide of Formula (III) has a number average molecular weight (Mₙ) of about 18 to about 26 kilograms per mole (kg/mol), such as about 19 to about 25 kg/mol, about 20 to about 24 kg/mol, about 21 to about 23 kg/mol, or about 22 kg/mol. In some embodiments, the melamine-containing copolyimide of Formula (III) has a weight average molecular weight (M_{w}) of about 31 to about 41 kg/mol, such as about 32 to about 40 kg/mol, about 33 to about 39 kg/mol, about 34 to about 38 kg/mol, about 35 to about 37 kg/mol, or about 36 kg/mol. In some embodiments, the melamine-containing copolyimide of Formula (III) has a polydispersity index (PDI) of about 1.5 to about 1.9, such as about 1.55 to about 1.85, about 1.6 to about 1.8, about 1.65 to about 1.75, or about 1.7.

In some embodiments, the melamine-containing copolyimide has a Formula (IV):

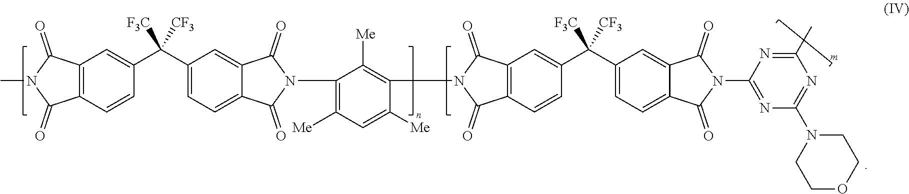

In certain embodiments of Formula (IV), m is 0.1 and n is 0.9. In some embodiments, the melamine-containing copolyimide of Formula (IV) has a Mₙ of about 10 to about 18 kilograms per kg/mol, such as about 11 to about 17 kg/mol, about 12 to about 16 kg/mol, about 13 to about 15 kg/mol, or about 14 kg/mol. In some embodiments, the melamine-containing copolyimide of Formula (IV) has a M_{w} of about 23 to about 33 kg/mol, such as about 24 to about 32 kg/mol, about 25 to about 31 kg/mol, about 26 to about 30 kg/mol, about 27 to about 29 kg/mol, or about 28 kg/mol. In some embodiments, the melamine-containing copolyimide of Formula (IV) has a PDI of about 1.7 to about 2.1, such as about 1.75 to about 2.05, about 1.8 to about 2, about 1.85 to about 1.95, or about 1.9.

Also provided in the present disclosure is a method of preparing the melamine-containing copolyimide. The method includes mixing monomers of 6FDA, an aromatic diamine, a melamine compound, and a solvent to form a first reaction mixture containing one or more polyamic acids. In some embodiments, the solvent is selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, and mixtures thereof. In some embodiments, the solvent is an organic solvent. In some embodiments, the solvent is dimethylformamide (DMF). In some embodiments, the aromatic diamine includes 2,4,6-trimethyl-m-phenylenediamine and 2,3,5,6-tetramethyl-p-phenylenediamine. In some embodiments, the aromatic diamine is 2,4,6-trimethyl-m-phenylenediamine. In some embodiments, the melamine compound has a Formula (V):

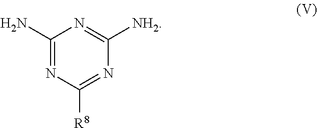

In some embodiments, R⁸ is selected from the group consisting of

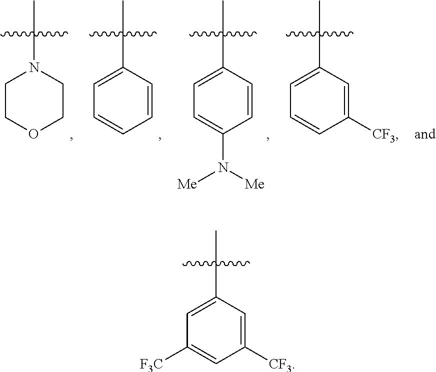

In some embodiments, the R⁸ is

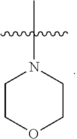 [SMILES: *N1CCOCC1]

In some embodiments, the R⁸ is

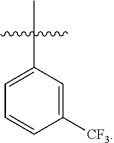 [SMILES: *c1cccc(C(F)(F)F)c1]

The method further includes mixing an amine base and an acetic anhydride to form a second mixture. In some embodiments, the amine base includes triethylamine, triethylene diamine, 1,8-diazabicyclo[5.4.0]undec-7-ene, 1,5-diazabicyclo[4.3.0]-5-nonene, 4-dimethylaminopyridine (DMAP), and pyridine. In some embodiments, the amine base is triethylamine.

The method further includes mixing the first reaction mixture and the second mixture, thereby reacting the one or more polyamic acids with the acetic anhydride to form a crude product mixture containing the melamine-containing copolyimide.

The method further includes adding the crude product mixture into water to precipitate the melamine-containing copolyimide from the crude product mixture.

The method further includes removing the melamine-containing copolyimide from the crude product mixture, washing with water, and drying at a temperature of about 70 to about 300° C., such as about 90 to about 250° C., about 110 to about 200° C., about 130 to about 150° C., or about 140° C. In some embodiments, the melamine-containing copolyimide is dried at a temperature of about 110 to about 200° C.

### Membranes

Also provided in the present disclosure are membranes including a melamine-containing copolyimide including a structural repeat unit of Formula (I) and a structural repeat unit of Formula (II). In some embodiments, the membrane includes any polymer of the present disclosure.

In some embodiments, the membrane includes at least about 80 wt % of the melamine-containing copolyimide. For example, in some embodiments, the membrane includes at least about 85 wt %, at least about 90 wt %, at least about 95 wt %, at least about 97.5 wt %, at least about 98 wt %, at least about 98.5 wt %, or at least about 99 wt % of the melamine-containing copolyimide.

### Methods for Preparing Membranes

Also provided in the present disclosure are methods for preparing a membrane containing the melamine-containing copolyimides of the present disclosure. Polymeric membranes are thin semipermeable barriers that selectively separate some gas compounds from others. The membranes are dense films that do not operate as a filter, but rather separate gas compounds based on how well the different compounds dissolve into the membrane and diffuse through it (the solution-diffusion model). The membranes of the present disclosure are useful for any gas separation application, including, but not limited to, natural gas sweetening, oxygen enrichment, hydrogen purification, and nitrogen and organic compounds removal from natural gas. In some embodiments, the membranes of the present disclosure are used for the separation of CO₂ and/or H₂S from a CO₂-containing gas mixture, such as natural gas.

In some embodiments, the method includes preparing a solution of any polymer of the present disclosure. In some embodiments, the melamine-containing copolyimide is added to a solvent and dissolved. In some embodiments, the solvent is selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, and mixtures thereof. In some embodiments, the solvent is an organic solvent. In some embodiments, the solvent is dimethylformamide (DMF). In some embodiments, the melamine-containing copolyimide is dissolved at room temperature. In some embodiments, the melamine-containing copolyimide is dissolved completely in the solvent before proceeding to the next step. In some embodiments, the melamine-containing copolyimide is filtered. In some embodiments, the melamine-containing copolyimide is filtered with a PTFE filter.

In some embodiments, the solution contains about 1 wt % to about 10 wt % the melamine-containing copolyimide, such as about 2 wt % to about 5 wt %, or about 3 wt % the melamine-containing copolyimide. In some embodiments, the solution containing the melamine-containing copolyimide is poured into a flat-bottomed container in order to prepare a film. In some embodiments, the film is dried to allow for evaporation of solvent. In some embodiments, the film is dried at an elevated temperature under a flow of nitrogen gas. In some embodiments, the film is further dried in a vacuum oven, for example, at about 100° C. to about 250° C., or about 150° C. to about 200° C. for at least about 4 hours, about 6 hours, about 12 hours, about 18 hours, about 24 hours, about 30 hours, about 36 hours, about 42 hours, about 48 hours, or more.

In some embodiments, after drying, the film is soaked in a second solvent. In certain such embodiments, the second solvent is deionized water. In some embodiments, the film is soaked in the second solvent for at least a few minutes or more. In some embodiments, the second solvent is removed from the film, and then the film is dried to provide the membrane. In some embodiments, the second solvent is removed from the film, and then the film is dried in a vacuum oven, for example, at about 60° C. for about 6 hours.

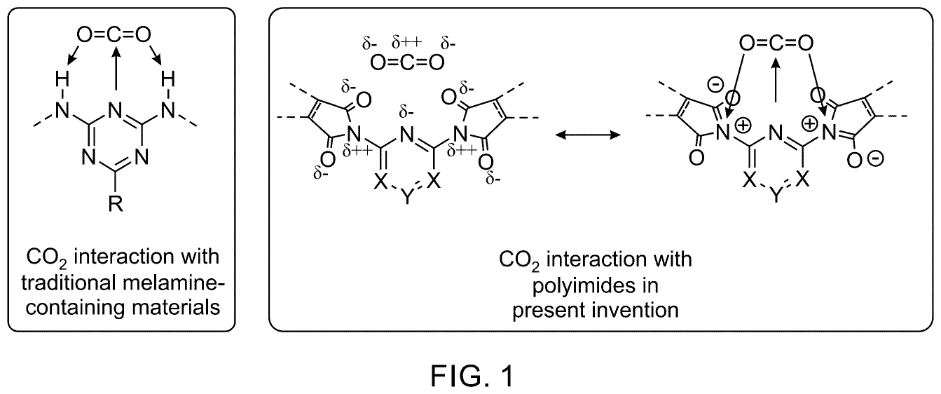

Also provided in the present disclosure are membranes prepared by the methods of the present disclosure. In general, for natural gas purification, it is desired to improve the permeability of impurities (such as carbon dioxide (CO₂) and hydrogen sulfide (H₂S)) and the membrane selectivities (CO₂/CH₄ and H₂S/CH₄) toward the main hydrocarbons constituting the natural gas (methane (CH₄)). In another aspect, it is desired to increase the plasticization resistance of the melamine-containing copolyimide membranes during high pressure mixed-gas separation. In some embodiments, the N—H groups of melamine present in the melamine-containing copolyimide can assist in CO₂ binding via hydrogen bonding to the oxygen atoms of CO₂. The incorporation of melamine comonomers into polyimides results in a moiety that has a quadripolar alignment to assist CO₂ binding by limiting the CO₂ mobility under harsh separation conditions of temperature and pressure, as depicted in FIG. 1. These melamine-containing copolyimides have shown improved physical and chemical stabilities, film formation capacity, and synthetic flexibility. In some embodiments, the membranes of the present disclosure demonstrate improved gas transport properties in natural gas separation, for example, sour gas separation, as compared to conventional polymer-based membranes that do not contain a melamine moiety. In some embodiments, the membranes of the present disclosure demonstrate high CO₂/CH₄ selectivity, high H₂S/CH₄ selectivity, and resistance to plasticization, as compared to conventional polyimide-based membranes that do not contain a melamine moiety, for example, at a temperature of about 25° C. and a feed pressure of about 100 psi, the CO₂/CH₄ selectivity of the present disclosure is about 38.8 as compared to that of a 6FDA-DAM polyimide membrane which is about 29.5. The membranes of the present disclosure also possess increased CO₂ permeation coefficients and comparable CO₂/CH₄ selectivity as compared to convention polyimide-based membranes that do not contain a melamine moiety.

### Methods of Using the Membranes

The gas separation membranes of the present disclosure provide an alternative energy efficient method. The membranes of the present disclosure possess a set of specifications related to their gas permeability (or permeance) (H₂S and CO₂) and selectivity (CO₂/CH₄) that allow this technology to compete or be conjugated with current technology. In some embodiments, the membranes exhibit mixed sour gas selectivity for CO₂/CH₄ from 10 up to 90 and permeance up to 150 Barrer for CO₂. Thus, the membranes of the present disclosure can be used in a bulk acid gas removal process. In some embodiments, the melamine-containing copolyimides and the melamine-containing copolyimide membranes provide for an improved membrane system for sweet and sour mixed-gas separation.

Thus, also provided in the present disclosure are methods for using a membrane of the present disclosure. In some embodiments, the methods include separating CO₂ from a CO₂-containing gas mixture, such as natural gas, by passing the CO₂-containing gas mixture through a melamine-containing copolyimide membrane containing the melamine-containing copolyimide to form a purified gas by absorbing the CO₂ and allowing the CO₂-containing gas mixture to pass through the melamine-containing copolyimide membrane. In some embodiments, the CO₂-containing gas mixture includes about 1 vol % to about 50 vol % of CO₂ before separating. For example, in some embodiments, the CO₂-containing gas mixture includes about 1 vol % to about 50 vol %, about 3 vol % to about 40 vol %, about 5 vol % to about 30 vol %, about 10 vol % to about 20 vol %, or about 15 vol % to about 20 vol % of CO₂ before separating. In some embodiments, the CO₂-containing gas mixture further includes one or more components selected from the group consisting of methane (CH₄), ethane (C₂H₆), propane (C₃H₈), butane (C₄H₁₀), nitrogen (N₂), hydrogen sulfide (H₂S), and water (H₂O) vapor.

In some embodiments, the CO₂-containing gas mixture includes CO₂ and CH₄. In some embodiments, the CO₂-containing gas mixture includes at least about 30 vol %, for example, at least about 40 vol %, or at least about 50 vol % of CH₄ before separating. In some embodiments, the CO₂-containing gas mixture includes about 1 vol % to about 50 vol % of CO₂ before separating. For example, in some embodiments, the CO₂-containing gas mixture includes about 1 vol % to about 50 vol %, about 3 vol % to about 40 vol %, about 5 vol % to about 30 vol %, about 10 vol % to about 20 vol %, or about 15 vol % to about 20 vol % of CO₂ before separating.

In some embodiments, the CO₂-containing gas mixture is contacted with the melamine-containing copolyimide membrane at a temperature of about 10 to about 50° C., such as about 15 to about 45° C., about 20 to about 40° C., about 25 to about 35° C., or about 30° C. In some embodiments, the CO₂-containing gas mixture is contacted with the melamine-containing copolyimide membrane at a temperature of 20 to about 30° C. In some embodiments, the CO₂-containing gas mixture is contacted with the melamine-containing copolyimide membrane at a pressure of about 50 to about 1200 pounds per square inch (psi), such as about 100 to about 1100 psi, about 200 to about 1000 psi, about 300 to about 900 psi, about 400 to about 800 psi, about 500 to about 700 psi, or about 600 psi. In some embodiments, the CO₂-containing gas mixture is contacted with the melamine-containing copolyimide membrane at a pressure of about 100 to about 800 psi.

In some embodiments, the CO₂-containing gas mixture contains CO₂ and CH₄. The method of using the melamine-containing copolyimide membrane has a CO₂/CH₄ selectivity of about 30 to about 50, or about 35 to about 45, or about 38.8 at a temperature of about 25° C. and a pressure of about 100 psi. In some embodiments, the method of using the melamine-containing copolyimide membrane has a CO₂/CH₄ selectivity of about 38.8 at 25° C. and 100 psi.

### EXAMPLES

### Example 1—Preparation of 6-morpholino-1,3,5-triazine-2,4-diamine (MEL-II)

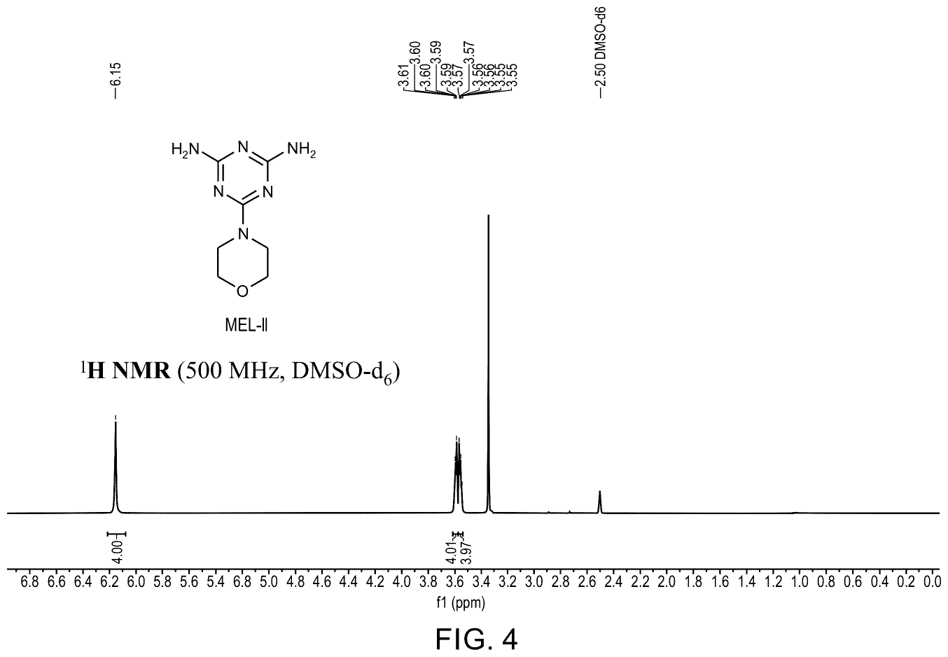

The compound 6-morpholino-1,3,5-triazine-2,4-diamine (MEL-II) was prepared according to Scheme 5. 2-chloro-4.6-diamino-1,3,5-triazine (10.0 g, 69 mmol, 1.0 equiv, 90% purity), morpholine (12.0 mL, 138 mmol, 2.0 equiv), K₂CO₃ (19.0 g, 138 mmol, 2.0 equiv), and DMF (50 mL) were added to a 250 mL flask equipped with a stir bar. The reaction mixture was stirred at 100° C. for 18 h. The reaction mixture was cooled down to room temperature and transferred to a 500 mL beaker. 200 mL saline water was added to the mixture and the mixture was cooled to 10° C. The precipitated crystal was separated by filtration. The collected product was washed several times by water and acetonitrile before drying in a vacuum oven at 100° C. overnight to provide 6-morpholino-1,3,5-triazine-2,4-diamine (MEL-II) as a white solid (8.3 g, 69% yield). MEL-II had a melting point of about 245 to about 255° C. ¹H NMR (FIG. 4) (500 MHz, DMSO-d₆) δ 6.15 (s, 4H), 3.61-3.58 (m, 4H), 3.57-3.54 (m, 4H). ¹³C NMR (126 MHz, DMSO-d₆) δ 167.2, 165.5, 66.1, 43.1. FTIR (neat, cm⁻¹) 3299, 3155, 1621, 1537, 1479, 1433, 1369, 1306, 1292, 1130, 1112, 1102, 1065, 998, 883, 810, 616, 582, 538.

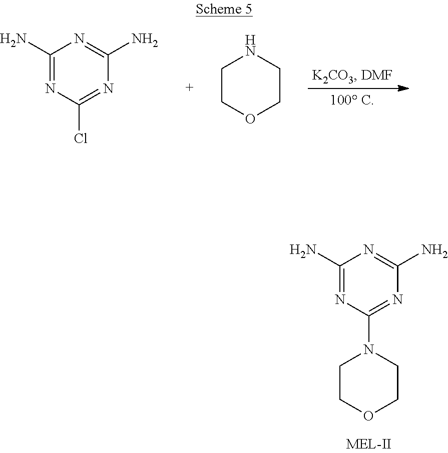 [SMILES: Nc1nc(N)nc(Cl)n1 ; C1COCCN1 ; Nc1nc(N)nc(N2CCOCC2)n1]

### Example 2—Preparation of 6-phenyl-1,3,5-triazine-2,4-diamine (MEL-I)

The compound 6-phenyl-1,3,5-triazine-2,4-diamine (MEL-I) was prepared according to Scheme 6. Benzonitrile (25 g, 0.24 mol), 2-cyanoguanidine (25.2 g, 0.3 mol) and 85 wt % KOH in 50 ml 2-methoxyethanol were added to a 250 mL flask equipped with a stir bar. The reaction mixture was heated under agitation. The reaction mixture was cooled down to room temperature and transferred to a 500 mL beaker. 200 mL saline water was added to the mixture and the mixture was cooled to 10° C. The precipitated crystal was separated by filtration. The collected product was washed several times by water and acetonitrile before drying in a vacuum oven at 100° C. overnight to provide 6-phenyl-1,3,5-triazine-2,4-diamine (MEL-I).

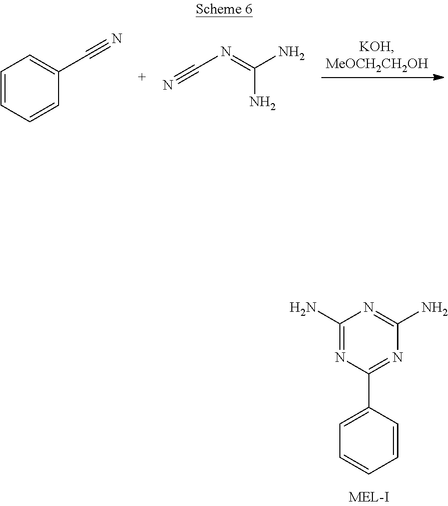 [SMILES: N#Cc1ccccc1 ; N#CN=C(N)N ; Nc1nc(N)nc(-c2ccccc2)n1]

### Example 3—Preparation of 6FDA-DAM/MEL Copolyimide

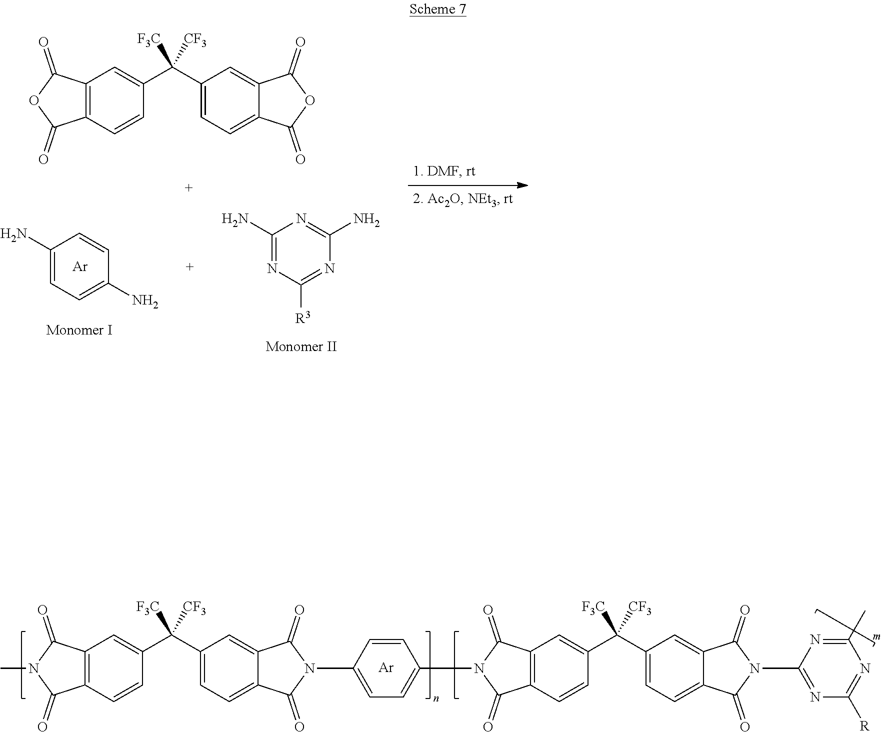

The 6FDA-DAM/MEL copolyimide can be prepared by following this general procedure as depicted in Scheme 7. An oven-dried Schlenk flask (purchased from Synthware™, modified, with PTFE stopcock, F909100, 100 mL) equipped with a stir bar was sequentially charged with diamine Monomer I (9.0 mmol, 0.9 equiv) and melamine Monomer II (1.0 mmol, 0.1 equiv). The reaction flask was evacuated and backfilled with nitrogen from the Schlenk line (this process was repeated a total of three times), then anhydrous DMF (12 mL) was added successively. The reaction mixture was stirred at room temperature for 5 min and then 4,4′-(hexafluoroisopropylidene)diphthalic anhydride (6FDA) (4.44 g, 10 mmol. 1 equiv) was added. The solution was stirred at room temperature for 24-48 hours to form polyamic acid. Next, a solution of triethylamine (1.4 mL, 10 mmol, 1 equiv) and acetic anhydride (3.8 mL, 40 mmol, 4 equiv) dissolved in anhydrous DMF (2 mL) was added. The mixture was vigorously stirred for 20 hours to allow complete imidization. The obtained mixture was diluted by adding 10 mL DMF, and then dropped slowly into water to obtain white polyimide fibers or balls. The collected polymer was washed several times by water before drying in a vacuum oven at 110-200° C. for 48 h.

### Example 4—Preparation of 6FDA-DAM/MEL-I Copolyimide (9:1) (P1)

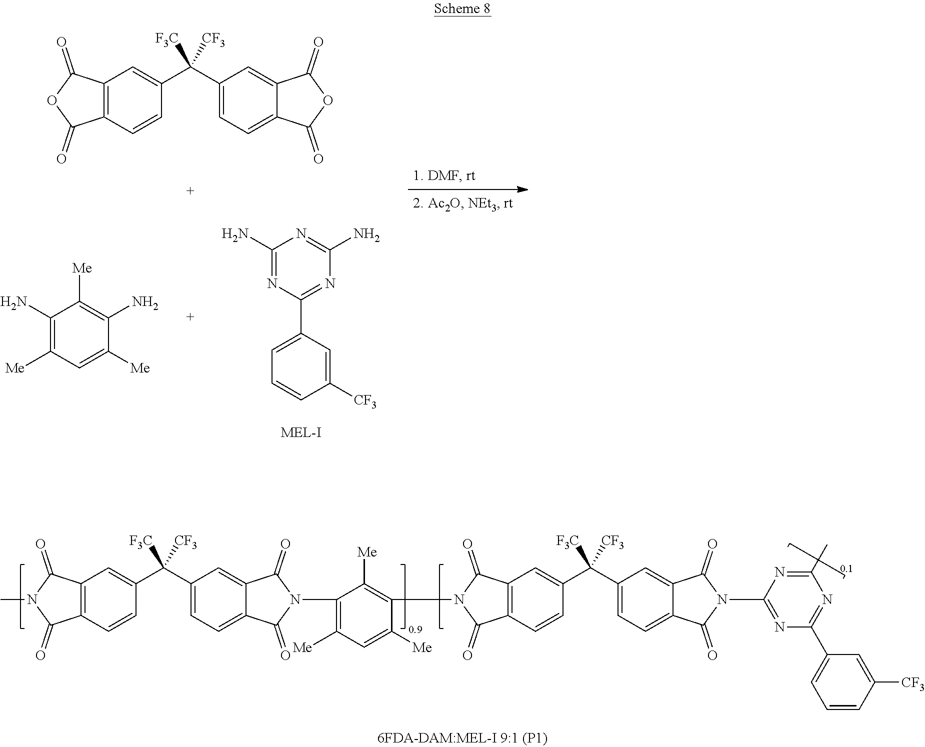

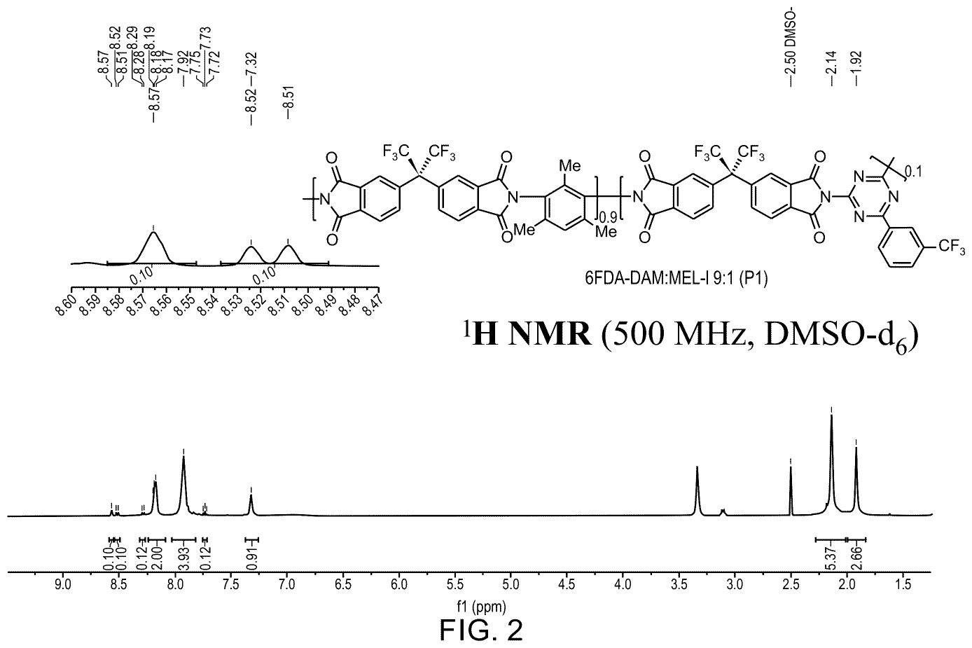

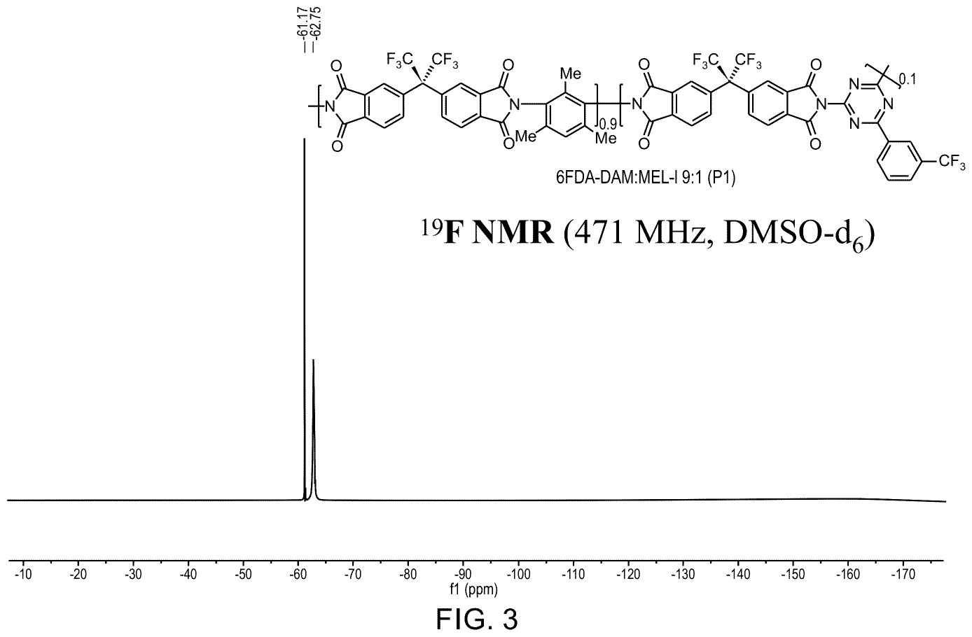

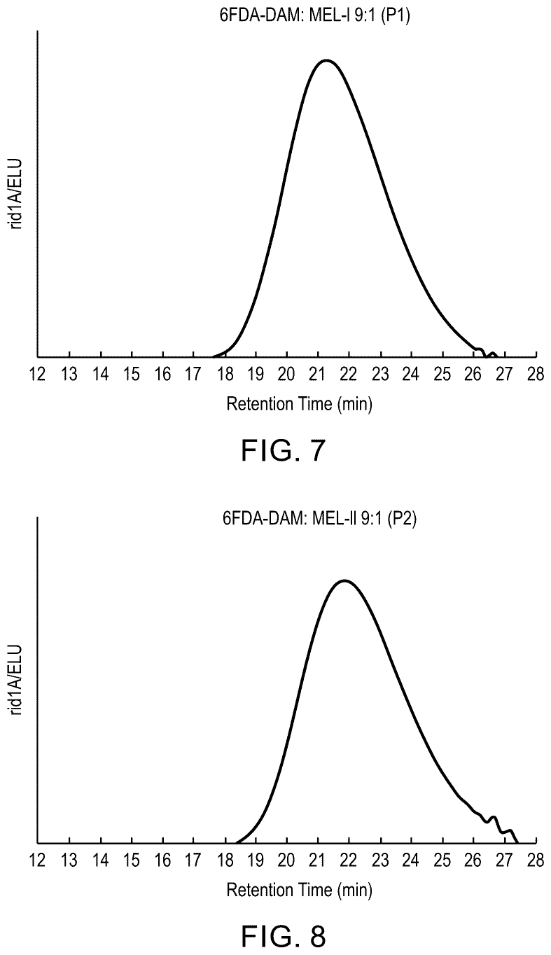

The 6FDA-DAM/MEL-I copolyimide (9:1) (P1) was prepared on a 10 mmol scale using 4,4′-(hexafluoroisopropylidene)diphthalic anhydride (6FDA)(4.44 g, 10 mol, 1.0 equiv), 2,4,6-trimethyl-m-phenylenediamine (DAM)(1.35 g, 9 mmol, 0.9 equiv), and 2,4-diamino-6-[3-(trifluoromethyl)phenyl]-1,3,5-triazine (MEL-I)(255 mg, 1.0 mmol, 0.1 equiv), as depicted in Scheme 8. The reaction mixture was stirred at room temperature for 72 h to form polyamic acid. After workup, the copolyimide P1 was obtained as white balls (5.41 g, 95% yield). 6FDA-DAM part: ¹H NMR (FIG. 2) (500 MHz, DMSO-d₆) δ 8.25-8.10 (m, 2H), 7.92 (s, 4H), 7.32 (s, 0.9H), 2.14 (s, 5.4H), 1.92 (s, 2.7H). Melamine part: δ 8.57 (s, 0.1H), 8.52 (d, J=7.9 Hz, 0.1H), 8.29 (d, J=8.2 Hz, 0.1H), 7.76-7.70 (m, 0.1H)¹⁹F NMR (FIG. 3) (471 MHz, DMSO-d₆) δ −61.2, −62.8. Based on ¹H-NMR, the ratio of DAM to MEL-I was 9:1. This ratio indicated that on average, 0.9 DAM and 0.1 MEL-I units were incorporated on each repeat unit of P1. FTIR (neat, cm⁻¹) 2934, 2857, 1791, 1728, 1630, 1484, 1435, 1359, 1294, 1254, 1207, 1147, 1105, 1027, 978, 962, 863, 814, 750, 724, 705, 624, 545. Molecular weight values were calculated using ChemStation GPC Data Analysis Software (Rev. B.01.01) based on the refractive index signal. Mn=21.7 kg/mol, Mw=36.6 kg/mol, PDI=1.7 (FIG. 7).

### Example 5—Preparation of 6FDA-DAM/MEL-II Copolyimide (9:1) (P2)

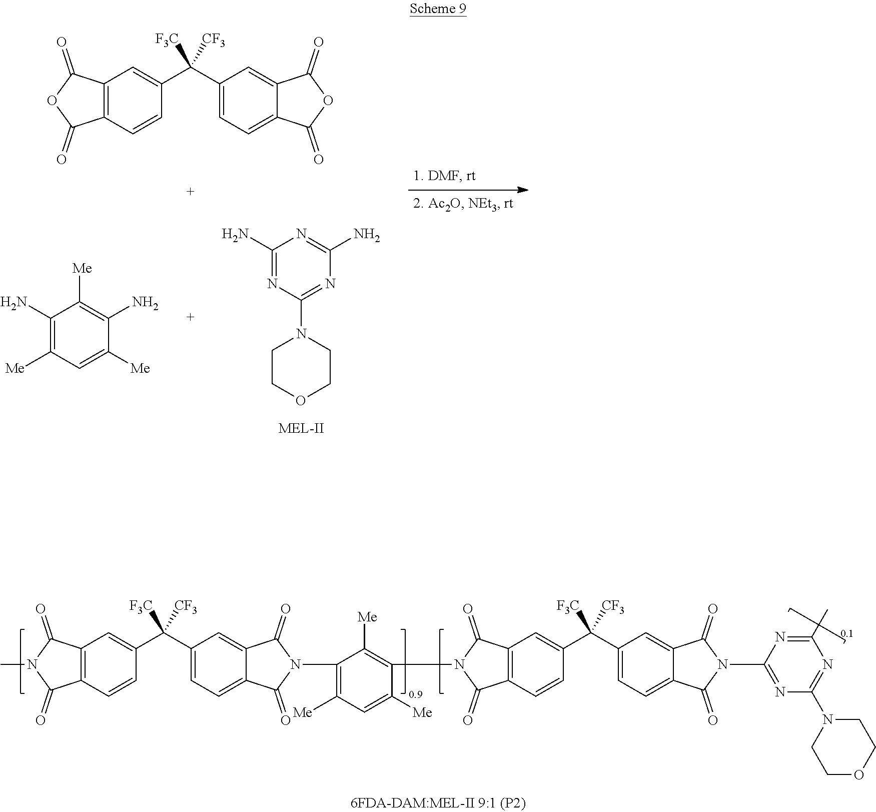

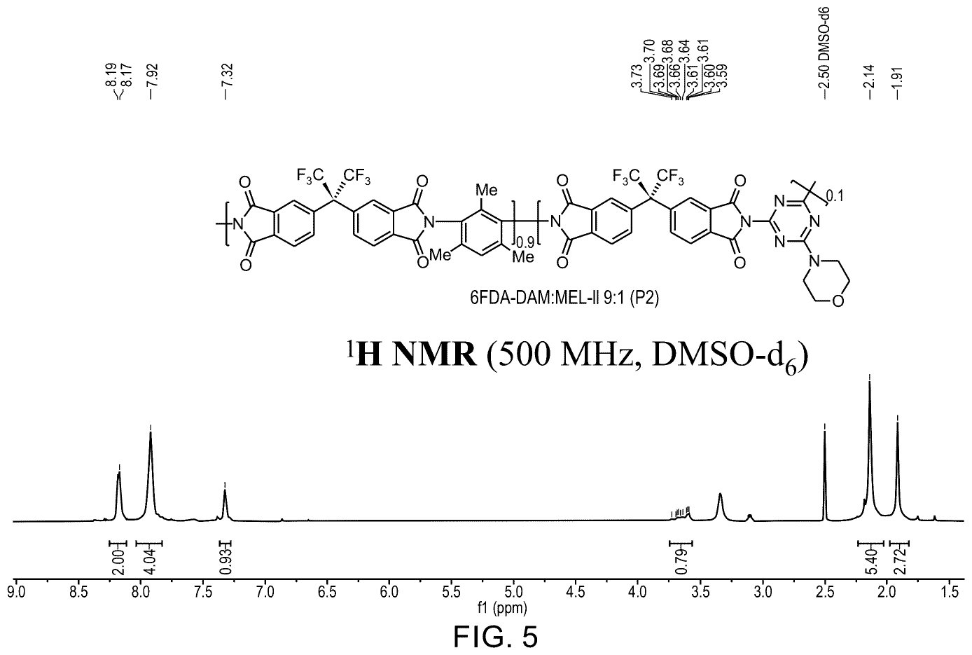

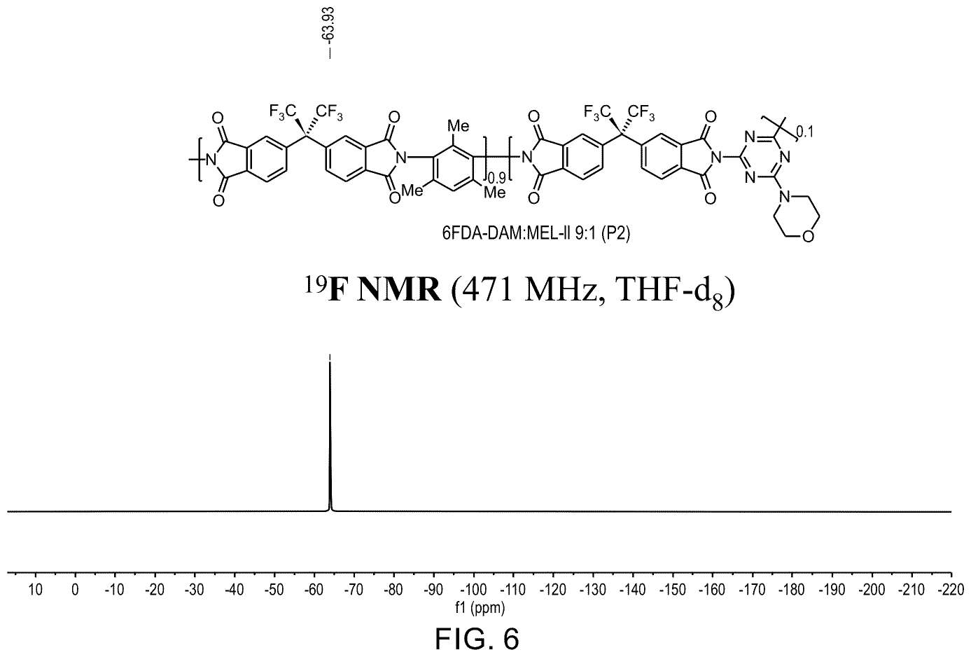

The 6FDA-DAM/MEL-II copolyimide (9:1) (P2) was prepared on a 10 mmol scale using 4,4′-(hexafluoroisopropylidene)diphthalic anhydride (6FDA) (4.44 g, 10 mol, 1.0 equiv), 2,4,6-trimethyl-m-phenylenediamine (DAM) (1.35 g, 9 mmol, 0.9 equiv), and 6-morpholino-1,3,5-triazine-2,4-diamine (MEL-II) (196 mg, 1.0 mmol, 0.1 equiv), as depicted in Scheme 9. The reaction mixture was stirred at room temperature for 72 h to form polyamic acid. After workup, the copolyimide P2 was obtained as white balls (5.35 g, 95% yield). 6FDA-DAM part: ¹H NMR (FIG. 5) (500 MHz, DMSO-d₆) δ 8.32-8.12 (m, 2H), 8.05-7.83 (m, 4H), 7.32 (s, 0.9H), 2.14 (s, 5.4H), 1.91 (s, 2.7H). Melamine part: δ 3.76-3.51 (m, 0.8H). ¹⁹F NMR (FIG. 6) (471 MHz, THF-d₈) δ −63.9. Based on ¹H-NMR, the ratio of DAM to MEL-II was 9:1. This ratio indicated that on average, 0.9 DAM and 0.1 MEL-II units were incorporated on each repeat unit of P2. FTIR (neat, cm₋₁) 2929, 2854, 1786, 1729, 1644, 1560, 1508, 1482, 1430, 1359, 1299, 1254, 1207, 1144, 1105, 1027, 971, 863, 812, 739, 722, 627, 543. Molecular weight values were calculated using ChemStation GPC Data Analysis Software (Rev. B.01.01) based on the refractive index signal. Mn=14.1 kg/mol, Mw=27.1 kg/mol, PDI=1.9 (FIG. 8).

### Example 6—Preparation of 6FDA-DAM Homopolyimide

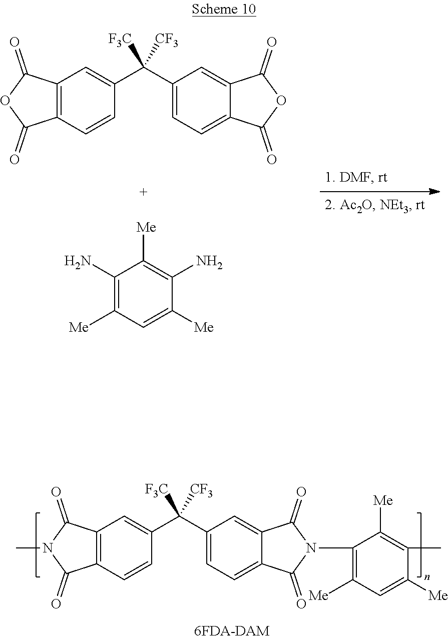

The 6FDA-DAM homopolyimide was prepared on a 10 mmol scale using (4,4′-hexafluoroisopropylidene) diphthalic anhydride (6FDA) (obtained from Akron Polymer Systems) and 2,4,6-trimethyl-1,3-diaminobenzene (DAM) (obtained from Akron Polymer Systems), as depicted in Scheme 10. All the chemicals and the solvents used in the experiment were used as received without further purification. An oven-dried Schlenk flask (purchased from Synthware™ modified, with PTFE stopcock, F909100, 100 mL) equipped with a stir bar was sequentially charged with 2,4,6-trimethyl-m-phenylenediamine (1.5 g, 10 mmol, 1.0 equiv). The reaction flask was evacuated and backfilled with nitrogen from the Schlenk line (this process was repeated a total of three times), then anhydrous DMF (12 mL) was added successively. The reaction mixture was stirred at room temperature for 5 min and then 4,4′-(hexafluoroisopropylidene)diphthalic anhydride (6FDA) (4.44 g, 10 mmol. 1 equiv) was added. The solution was stirred at room temperature for 24-48 hours to form polyamic acid. Next, a solution of triethylamine (1.4 mL, 10 mmol, 1 equiv) and acetic anhydride (3.8 mL, 40 mmol, 4 equiv) dissolved in anhydrous DMF (2 mL) was added. The mixture was vigorously stirred for 20 hours to allow complete imidization. The obtained mixture was diluted by adding 10 mL DMF, and then dropped slowly into water to obtain white polyimide fibers or balls. The collected polymer was washed several times by water before drying in a vacuum oven at 150° C. for 48 h.

### Example 7—Preparation of 6FDA-DAM/DABA Copolyimide (3:2)

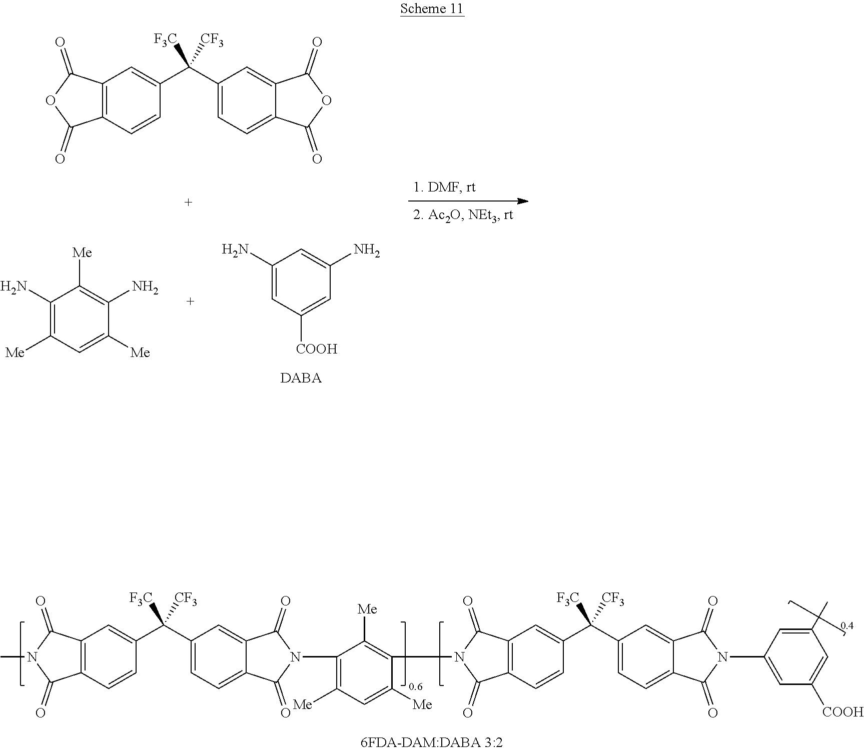

The 6FDA-DAM/DABA (3:2) copolyimide was prepared from (4,4′-hexafluoroisopropylidene) diphthalic anhydride (6FDA) (obtained from Akron Polymer Systems), 3,5-diaminobenzoic acid (DABA) (obtained from Akron Polymer Systems), and 2,4,6-trimethyl-1,3-diaminobenzene (DAM) (obtained from Akron Polymer Systems), as depicted in Scheme 11. All the chemicals and the solvents used in the experiment were used as received without further purification. 17.77 g of 6FDA was washed into flask with 125 mL of ethanol and 10 mL of triethylamine equipped with a mechanical stirrer, nitrogen inlet, and a dean-stark trap filled with ethanol. The mixture was heated to reflux under nitrogen flow for 1 hour, followed by distillation of excess triethylamine and ethanol to form viscous ester-acid solution. Afterwards, 2.43 g of DABA and 3.6 g of DAM were added with 128 mL of N-methyl-2-pyrrolidone (NMP) and 32 mL of orthodichlorobenzene (4/1 v/v). The dean-stark trap was drained and refilled with o-dichlorobenzene and the reaction was heated gradually to 180° C. under N₂ flow. After 48 hours, a viscous solution was precipitated in 1500 mL of methanol and precipitates were collected and dried at 80° C. overnight to give 20.8 g of off-white copolyimide polymer. The 6FDA-DAM/DABA (3:2) copolyimide was characterized by NMR in DMSO-d6, featured with the absence of amino peaks at about 4.7 ppm, indicating no residual unreacted reactant.

### Example 8-6FDA-DAM/MEL-I (P1) Copolyimide Membrane Preparation

The copolyimide dense film membrane was prepared by a solution casting method: 0.4 g of vacuum dried P1 polymer was dissolved in 6 mL of tetrahydrofuran (TIF) and the solution was filtered through a 0.2 μm PTFE filter. The solution was then cast on a clean PTFE mold dish and left to evaporate for 48 hours at room temperature with a cover. The film was then heated slowly in a vacuum oven to 120-150° C. for 48 hours to remove any residual solvent, and then cooled slowly to room temperature. The resulting copolyimide dense film had a thickness of about 10-100 μm.

### Example 9-6FDA-DAM/MEL-II (P2) Copolyimide Membrane Preparation

The copolyimide dense film membrane was prepared by a solution casting method: 0.4 g of vacuum dried P2 polymer was dissolved in 6 mL of THE and the solution was filtered through a 0.2 μm PTFE filter. The solution was then cast on a clean PTFE mold dish and left to evaporate for 48 hours at room temperature with a cover. The film was then heated slowly in a vacuum oven to 120-150° C. for 48 hours to remove any residual solvent, and then cooled slowly to room temperature. The resulting copolyimide dense film had a thickness of about 10-100 μm.

### Example 10—Chemical Characterization

The chemical structures and purity of the compounds described in Examples 1-7 were confirmed using proton nuclear magnetic spectroscopy (¹H NMR) in corresponding deuterated solvents (i.e., DMSO-d₆).

The chemical structure of the MEL monomer, such as MEL-II, was confirmed by ¹H NMR spectrum in deuterated DMSO-d₆ as illustrated in FIG. 4. The spectrum depicts the multiplet peak for the —CH₂— groups at 3.61-3.58 ppm and 3.57-3.54 ppm, and the primary amine protons represented as a singlet peak at 6.15 ppm. The absence of any other peaks in the spectrum (other than those from the deuterated solvent: H₂O at 3.46 ppm, and DMSO at 2.50 ppm) indicate the high purity of the prepared MEL monomer.

The presence of functional groups within the structure of MEL monomer, such as the primary amine groups, was confirmed using Fourier Transform Infrared (FTIR) spectroscopy. For example, the primary amine stretching bands (N—H) were depicted between 3299 cm⁻¹, while the peak at 1621 cm⁻¹ can be assigned to the primary amine N—H bending. Moreover, the peak at 1479-1433 cm⁻¹ was attributed to the carbon-hydrogen bond (CH₂) bending.

In a similar fashion, the chemical structures and purity of the final product of the polymers described in Examples 1-7 were confirmed using ¹H-NMR in DMSO-d₆. For example, the ¹H-NMR of the 6FDA-DAM/MEL-I copolyimide (9:1) (P1) was measured in DMSO-d₆ and was depicted in FIG. 2, while the ¹H-NMR of the 6FDA-DAM/MEL-II copolyimide (9:1) (P2) was measured in DMSO-d₆ and it was depicted in FIG. 5. The absence of any undesired peaks within the spectrum was an indication of the high purity of the prepared polymer.

For the copolyimides of Examples 3-5 and 7, in addition to determining their chemical structures and purities, the ¹H NMR spectra were further used to determine the molecular ratio of the co-monomers within the copolymer backbone. For example, the desired molar ratio between the co-monomers DAM and MEL in the 6FDA-DAM/MEL-I (9:1) block copolymer described in Example 4 was calculated from the area integration of the aromatic peaks of MEL-I and aliphatic peaks of DAM, from the spectrum illustrated in FIG. 2.

For instance, the DMA monomer has one aromatic proton and 9 aliphatic protons, which appear as two singlets at 1.92 ppm and 2.14 ppm, that correspond to its three methyl groups. If the total integration of the aromatic peaks that correspond to MEL-I were set for a total of 4 protons that correspond to one MEL-I molecule, the two singlets at 1.92 ppm and 2.14 ppm for DMA integrates for 81 protons, which indicates a molar ratio of 9:1 between DMA and MEL-I co-monomers. In a similar way, the molar ratios between DMA and MEL-II comonomers in 6FDA-DAM/MEL-II copolyimide (P2) (Example 5) were determined using their corresponding ¹H NMR spectra.

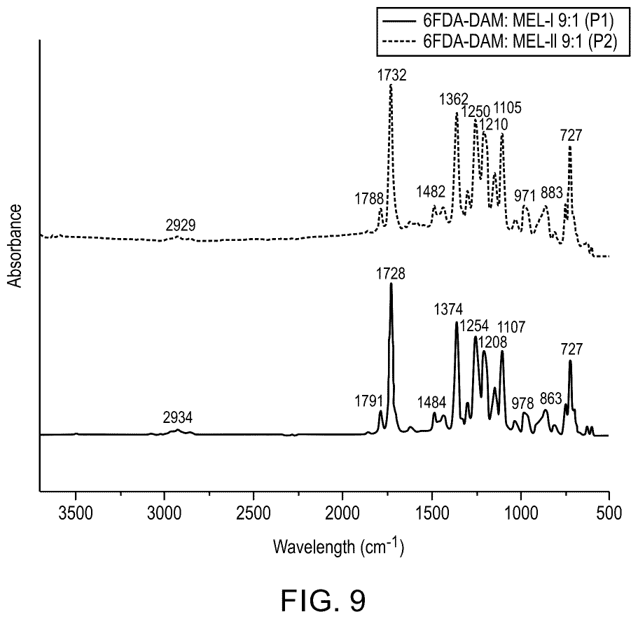

The FTIR spectrum of all of the described polymers were recorded to ensure that the polycondensation reactions were complete (FIG. 9). The FTIR spectra of 6FDA-DAM/MEL-1 (P1) and 6FDA-DAM/MEL-II (P2) copolyimides demonstrated the complete imidization formation evidenced by the absence of any peaks containing amide groups in the wavenumber range of 3100 cm⁻¹ to 3500 cm⁻¹. The FTIR spectrum also showed the symmetric imide carbonyl stretching at 1728-1732 cm⁻¹ and asymmetric imide carbonyl stretching at 1786-1791 cm⁻¹.

The molar mass distribution profiles of the copolyimides were determined by gel permeation chromatography (GPC). It was found that the copolyimide of the present disclosure has a unimodal distribution, as depicted in FIGS. 7-8. The number average molecular weight (Mn), the weight average molecular weight (Mw) and polydispersity index (PDI) values of the polymers were interpolated from the calibration plot and listed in Table 1.

TABLE 1
Molecular weight and molecular weight
distribution of the synthesized copolyimides

| Polymer | Mₙ (kg/mol) | M_{w} (kg/mol) | PDI |
|---|---|---|---|
| 6FDA-DAM/MEL-1 (9:1) (P1) | 21.7 | 36.6 | 1.7 |
| 6FDA-DAM/MEL-2 (9:1) (P2) | 14.1 | 27.1 | 1.9 |

### Example 11—Thermal and Physical Properties

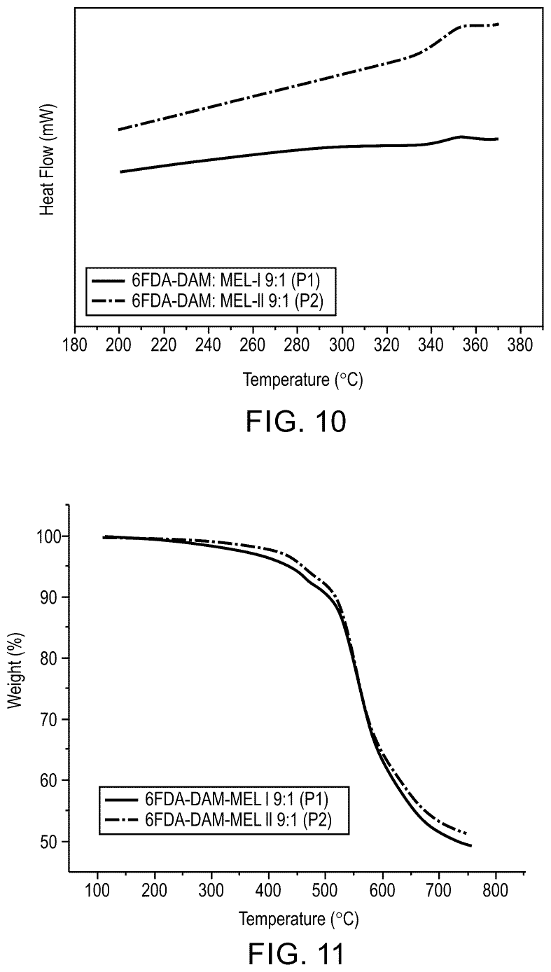

The thermal properties of the prepared polymers and membranes were characterized thermally via differential scanning calorimetry (Discovery DSC, 200 to 380° C. at a scanning rate of 10° C./min) and thermogravimetric analysis (Discovery TGA, 30 to 800° C. at a scanning rate of 10° C./min). The results were illustrated in FIGS. 10-11 and Table 2. The DSC results of 6FDA-DAM/MEL-I (9:1) (P1) and 6FDA-DAM/MEL-II (9:1) (P2) were shown in FIG. 10. The glass transition temperatures (T_{g}) of the polymers described in Examples 2-7 were calculated from their corresponding DSC traces and the values were listed in Table 2. To obtain the T_{g} values, polymer samples were heated for two cycles. The first heating cycle was used to clear the thermal history of the polymer, where the T_{g} was recorded after the second heating cycle. All the recorded T_{g} values were greater than 340° C. These high temperatures indicated the rigidity of the polymeric chains, which could be correlated to their performance during gas separation testing. The values obtained were similar to other glassy polymers used in gas separation technology. The glass transition temperature (T_{g}) for both 6FDA-DAM/MEL-I (9:1) (P1) and 6FDA-DAM/MEL-II (9:1) (P2) polyimides were 348° C. and 350° C. respectively, indicating a high thermal stability of the melamine-containing 6FDA-based copolyimides.

The thermographs of 6FDA-DAM/MEL-I (9:1) (P1) and 6FDA-DAM/MEL-II (9:1) (P2) co-polyimide membranes were shown in FIG. 11. Compared to neat 6FDA-DAM homo-polyimide and other type of comonomers, both 6FDA-DAM/MEL-I (9:1) (P1) and 6FDA-DAM/MEL-II (9:1) (P2) copolyimides containing melamine co-monomers with different substituted groups had low glass transition temperature (T_{g}), indicating the reduced polymer chain rigidity after the introduction of melamine comonomers in the polymer backbone. On the other hand, the resulting melamine-containing copolyimide membranes made by the 6FDA-DAM/MEL-I (9:1) (P1) and 6FDA-DAM/MEL-II (9:1) (P2) copolyimides showed improved thermal stability at high temperature. The decomposition temperatures at 5% and 10% were determined (Table 2) to evaluate the thermal stability of the prepared copolyimides and membranes during the harsh industrial conditions of gas separation application. For example, the T_{d5%} and T_{d10%} values for P1 and P2 melamine-containing copolyimides ranged from 437° C. to 460° C., and 509° C. to 519° C., respectively.

TABLE 2
Thermal and physical properties of 6FDA-DAM homo-polyimide,
6FDA-DAM/MEL-I (P1) and 6FDA-DAM/MEL-II (P2) co-polyimides

| Membranes | T_{g} (° C.) | T_{d@5wt%} (° C.) | T_{d@10wt%} (° C.) |
|---|---|---|---|
| 6FDA-DAM (Neat) | 395 | 433.2 | 443.1 |
| 6FDA-DAM/CARDO (1:1) | 393 | 525.0 | 544.0 |
| 6FDA-DAM/MEL-I (P1) | 348 | 437.0 | 508.7 |
| 6FDA-DAM/MEL-II (P2) | 350 | 460.5 | 518.7 |

### Example 12—Membrane Permeation Measurements

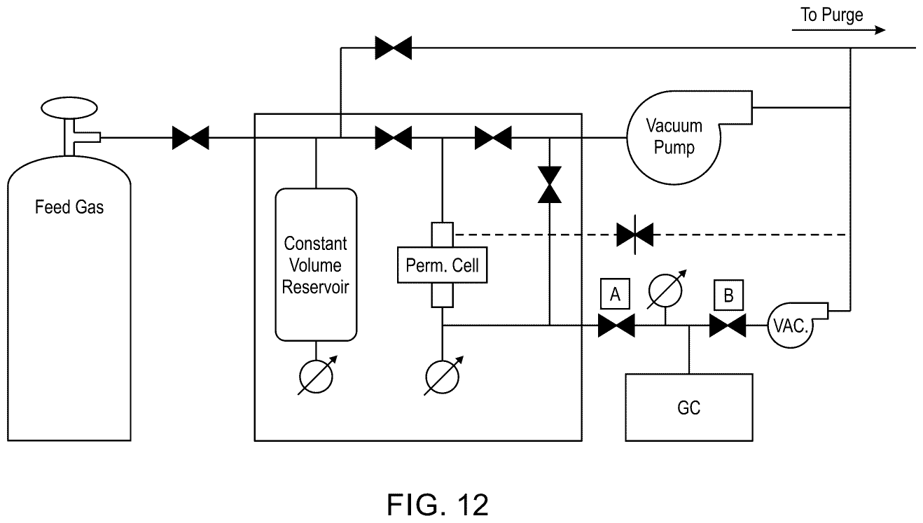

Gas permeation tests were performed in triplicate using a constant-volume, variable-pressure technique. A schematic diagram of this custom-built permeation apparatus was shown in FIG. 12. A stainless-steel permeation cell with 47 mm disc filters was purchased from EMD Millipore. An epoxy-masked membrane sample 5-20 mm in diameter was inserted and sealed in the testing cell, and the permeation system was completely evacuated overnight before each test. Pure gas permeability coefficients were measured at 25° C. and feed pressure of 100 psi in the order of CH₄ followed by CO₂ to avoid swelling. Steady-state permeability was calculated and verified by the time-lag method, where 10 times the diffusion time-lag was taken as the effective steady-state. The upstream (feed) pressure and the downstream (permeate) pressure were measured using Baraton absolute capacitance transducers (MKS Instruments) and recorded using LabVIEW software. The permeate pressure was maintained below 100 torr. Mixed gas permeation was performed at 25° C. and feed pressure range of 100 psi to 800 psi. A retentate stream was added for mixed gas tests and adjusted to 100 times the permeate flow rate to maintain less than 1% stage cut. The permeate gas was collected and then injected into a Shimadzu gas chromatograph (GC-2014) to measure permeate composition. Permeate injections were performed at 15 torr. An Isco pump (Teledynelsco) was used to control the feed pressure.

Permeability coefficients of gas i, Pᵢ, were calculated according to Equation 1, where dpᵢ/dt is the slope of the steady state pressure rise in the downstream, V is the downstream volume, R is the ideal gas constant, T is the temperature of the downstream, L is the membrane thickness (determined via JEOL 7100F scanning electron microscopy images of membrane cross sections), A is the membrane surface area (estimated using ImageJ image processing software), and Δfᵢ is the partial fugacity difference across the membrane calculated using the Peng-Robinson equation. Permselectivity, α_{i/j}, was calculated as the ratio of permeability coefficients as expressed in Equation 2.

$${P}_{i} = \frac{d {p}_{i}}{dT} \frac{V L}{RTA Δ {f}_{i}} \qquad Eq ( 1 )$$

$${α}_{i / j} = \frac{{P}_{i}}{{P}_{j}} \qquad Eq ( 2 )$$

### Example 13—Membrane Pure Gas Permeation Measurements

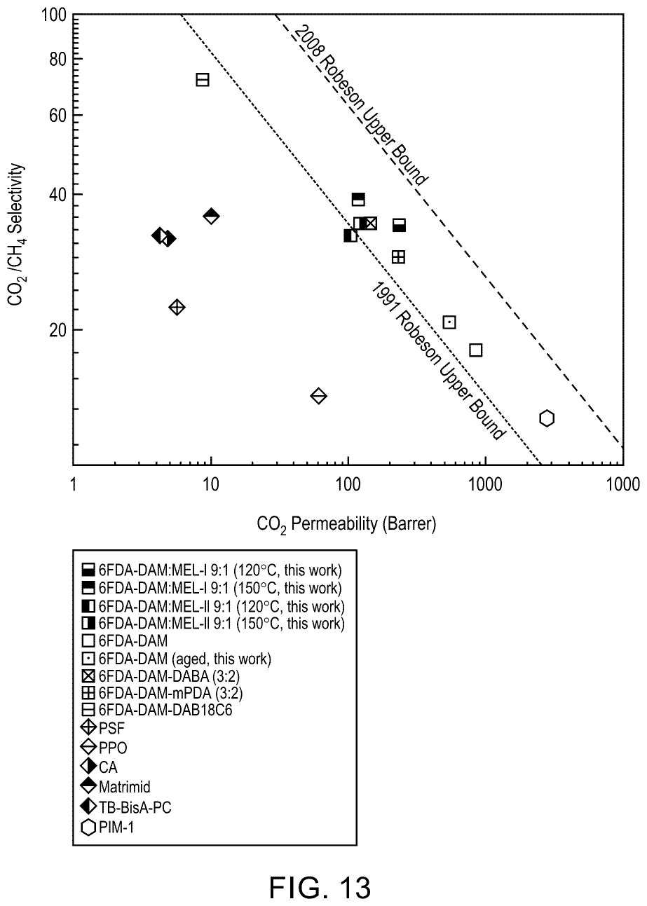

Ideal transport properties, measured by pure gas permeation, provide preliminary material observations and comparisons. The separation efficiency for gas pairs and membrane permeability were trade-off parameters (Robeson upper bound) since permeability increases with a decrease in selectivity. The pure gas permeation properties for conventional 6FDA-based membranes (e.g., 6FDA-DAM and 6FDA-DAM/DABA copolyimide membranes) and two melamine containing 6FDA-based copolyimide membranes (e.g., P1 and P2) of the present disclosure were tested at 25° C. and feed pressure of 100 psi as shown in Table 3. The separation performance of melamine-containing 6FDA-based copolyimides (e.g., P1 and P2) was compared via the permeability-selectivity trade-off plot in FIG. 13.

TABLE 3
Single gas permeation results for 6FDA-DAM/MEL-I (P1) and
6FDA-DAM/MEL-II (P2) for CO₂/CH₄ separation

| | P_{CO2} | P_{CH4} | α | α _{CO2/CH4} |
|---|---|---|---|---|
| Membranes | (Barrer) | Barrer) | CO₂/CH₄ | increased |
| 6FDA-DAM (Neat) | 542.6 | 26.09 | 20.8 | — |
| 6FDA-DAM/DABA | 51.50 | 1.17 | 44.13 | 112% |
| (3:2) (110° C.) | | | | |
| 6FDA-DAM/mPDA | 238.93 | 7.94 | 29.0 | 39% |
| (3:2) (180° C.) | | | | |
| 6FDA-DAM/DAB18C6 | 8.60 | 0.12 | 74.78 | 259% |
| (1:1) (110° C.) | | | | |
| 6FDA-DAM/CARDO | 170.0 | 6.37 | 26.7 | 28% |
| (1:1) (180° C.) | | | | |
| 6FDA-DAM/MEL-I (9:1) | 232.72 | 6.82 | 34.10 | 64% |
| (120° C.) (P1) | | | | |
| 6FDA-DAM/MEL-I (9:1) | 118.38 | 3.05 | 38.79 | 86% |
| (150° C.) (P1) | | | | |
| 6FDA-DAM/MEL-II (9:1) | 104.61 | 3.24 | 32.27 | 55% |
| (120° C.) (P2) | | | | |
| 6FDA-DAM/MEL-(9:1) | 121.75 | 3.54 | 34.41 | 65% |
| (150° C.) (P2) | | | | |

The 6FDA-DAM homopolymer had a good permeability due to its high free volume from the rigid DAM structure that frustrates polymer chain packing. With moderate selectivity and extremely high permeability, the separation performance of 6FDA-DAM lies above the upper bound. The 6FDA-DAM homopolymer synthesized by following Example 6 was aged for a month in a desiccator and tested for its CO₂/CH₄ separation performance.

The CO₂/CH₄ selectivity of crown ether-containing 6FDA-based co-polyimide (6FDA-DAM/DAB18C6) membrane was located at the far upper left quadrant, indicating significant enhanced separation ability, but a decreased permeability of under 10 Barrer makes it challenging for 6FDA-DAM/DAB18C6 to be of practical use in industrial applications. The results showed that the addition of flexible crown ether monomer (e.g., DAB18C6) reduced fraction free volume, thus the more efficiently packed polymer chains can discriminate gas molecules of different sizes more efficiently at the expense of lowering permeability due to lower free volume.

By controlling the thermal treatment temperature, the melamine-containing 6FDA-based copolyimides of the present disclosure, e.g., 6FDA-DAM/MEL-I (9:1) (P1) and 6FDA-DAM/MEL-II (9:1) (P2), showed enhanced separation performance. As can be seen from Table 3, the highest performing membrane 6FDA-DAM/MEL-I (9:1) P1, thermally treated at 150° C., can achieved an 86% increase in CO₂/CH₄ selectivity (CO₂/CH₄ selectivity of 39), compared to the neat 6FDA-DAM homo-polyimide membrane. This was likely due to the strong affinity of melamine towards CO₂ and other sour gases. The strong competitive sorption of CO₂ outcompetes the sorption of CH₄, thus increasing the selectivity of CO₂/CH₄ gas pair. A reduction in permeability was also observed, since melamine was less bulky than the DAM structure due to the lack of three methyl groups. The melamine-containing 6FDA-based copolyimides of the present disclosure not only outperformed the commercially available polymers, such as the 6FDA-DAM polymer, but they were also comparable and even outperformed the copolyimides such as 6FDA-DAM-DABA that have been applied in the realm of natural gas separation for many years. For example, melamine-containing 6FDA-DAM/MEL-I (9:1) (P1) and 6FDA-DAM/MEL-II (9:1) (P2) copolyimides show improvement in membrane permeability (104%-350% in CO₂ permeability), as compared to 6FDA-DAM-DABA membrane.

Referring now to FIG. 13, the membrane permeability-selectivity trade-off (CO₂/CH₄ vs. CO₂ permeability) of melamine based copolyimides was compared to that of the conventional 6FDA-based membranes. FIG. 13 demonstrated 6FDA-DAM (open square), 6FDA-DAM aged in this work (open square with dot), 6FDA-DAM/DABA copolyimide (open square with cross), 6FDA-DAM-mPDA copolyimide (open square with plus), 6FDA-DAB18C6 (open square with horizontal line), and melamine-based 6FDA-DAM copolymer (half-filled square) in pure gas (tested at 25° C. and 100 psi). 6FDA-DAM/MEL-I (9:1) membrane was dried at 120° C. as shown in bottom half-filled square, 6FDA-DAM/MEL-I (9:1) membrane was dried at 150° C. as shown in top half filled square, 6FDA-DAM/MEL-II (9:1) membrane was dried at 120° C. shown in left half-filled square, 6FDA-DAM/MEL-II (9:1) membrane was dried at 150° C. shown in right half-filled square.

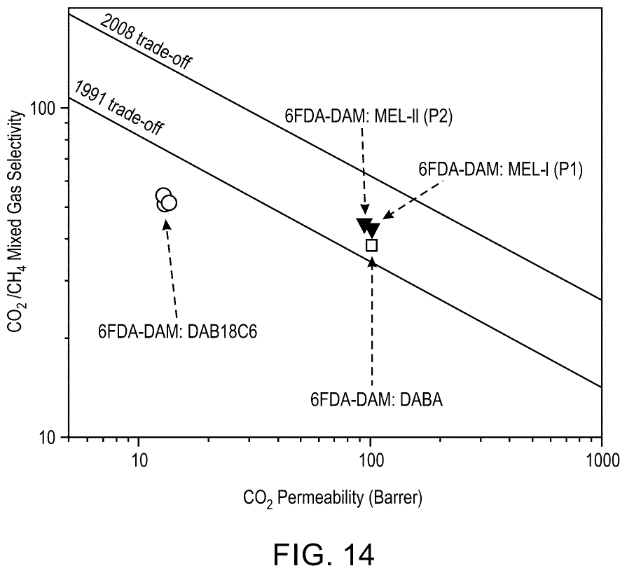

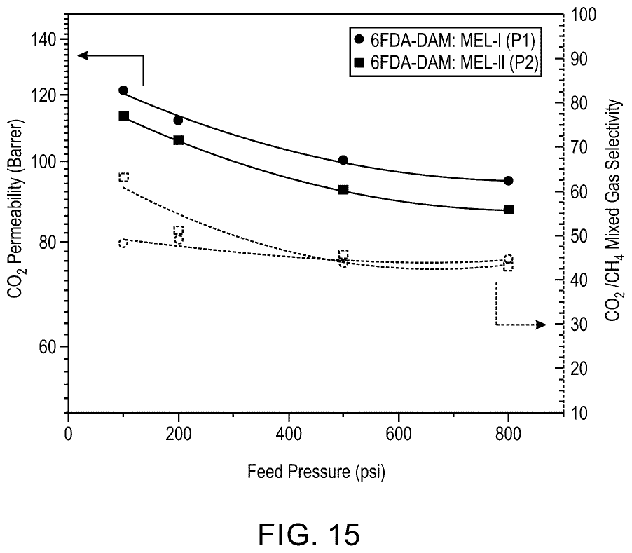

The membrane mixed gas permeation properties of the melamine-containing copolyimide membranes were tested at 25° C. and in the feed pressure range of 100 psi to 800 psi with CO₂/CH₄ (20/80 vol %) binary gas mixture. Results were listed in Table 4. FIGS. 14 and 15 showed the CO₂—CH₄ binary gas mixture separation performance against the Roberson upper bound for CO₂/CH₄ separation at the feed pressure of 800 psi. Under the same testing conditions, the melamine-containing 6FDA-DAM/MEL-I (P1) and 6FDA-DAM/MEL-II (P2) copolyimide membranes showed comparable CO₂ permeability but improved separation performance (12-17% increase in CO₂/CH₄ mixed gas selectivity at 800 psi), as compared to the 6FDA-DAM:DABA copolymer membrane.

TABLE 4
Binary gas mixture (20% CO₂/80% CH₄) permeation
results of melamine-containing 6FDA-DAM/MEL-I
(P1) and 6FDA-DAM/MEL-II (P2) for CO₂/CH₄ separation
tested at 25° C. in the feed range from 100 psi to 800 psi

| | Pressure | P_{CO2} | P_{CH4} | α |
|---|---|---|---|---|
| Membranes | (psi) | (Barrer) | (Barrer) | CO₂/CH₄ |
| 6FDA-DAM/DABA | 800 | 101.20 | 2.60 | 38.30 |
| (3:2) | 100 | 113.18 | 1.80 | 63.11 |
| 6FDA-DAM/MEL-I | 200 | 105.70 | 2.06 | 51.23 |
| (9:1) (P1) | 500 | 92.29 | 2.02 | 45.69 |
| | 800 | 101.41 | 2.38 | 42.92 |
| 6FDA-DAM/MEL-II | 100 | 121.51 | 2.52 | 48.21 |
| (9:1) (P2) | 200 | 111.99 | 2.28 | 49.14 |
| | 500 | 100.26 | 2.30 | 43.64 |
| | 800 | 94.67 | 2.12 | 44.59 |

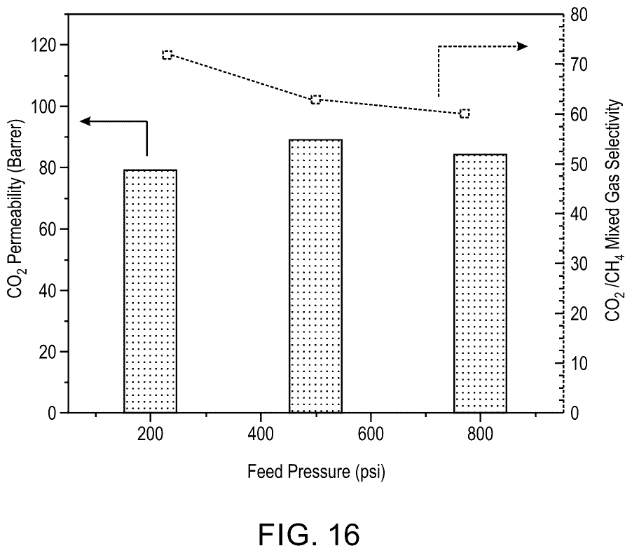

The melamine-containing 6FDA-DAM/MEL copolyimides of the present disclosure were subjected to a quaternary gas mixture (sweet gas mixture) at elevated feed pressure (up to 800 psi) to mimic the harsh conditions encountered in industrial applications. The separation properties of 6FDA-DAM/MEL-II (9:1) (P2) membrane under the feed pressure range of 200 psi to 800 psi were listed in Table 5 and illustrated in FIG. 16. Similar trends were observed as in binary gas mixture, the membrane separation performance (CO₂/CH₄ selectivity) decreased with increasing the feed pressure. For example, results showed that the 6FDA-DAM/MEL-II (9:1) (P2) membrane had a CO₂ permeability of 72.26 Barres and a CO₂/CH₄ selectivity of 70.91 at elevated feed pressure of 800 psi, which demonstrated enhanced separation performance compared to that under the binary gas mixture.

TABLE 5
Sweet gas mixture (10% CO₂/30% N₂/1% C₂H₆/59% CH₄) permeation results
of melamine-containing 6FDA-DAM/MEL-II (P2) for CO₂/CH₄ separation
tested at 25° C. in the feed range from 200 psi to 800 psi

| | Pressure | P_{CO2} | P_{CH4} | P_{N2} | P_{C2H6} | α | α |
|---|---|---|---|---|---|---|---|
| Membrane | (psi) | (Barrer) | (Barrer) | (Barrer) | (Barrer) | CO₂/CH₄ | N₂/CH₄ |
| 6FDA-DAM/MEL-II (9:1) (P2) | 200 | 78.95 | 1.10 | 2.72 | 2.06 | 71.76 | 2.23 |
| | 500 | 89.11 | 1.42 | 2.29 | 2.69 | 62.83 | 1.61 |
| | 800 | 84.09 | 1.40 | 2.22 | 2.13 | 60.05 | 1.58 |

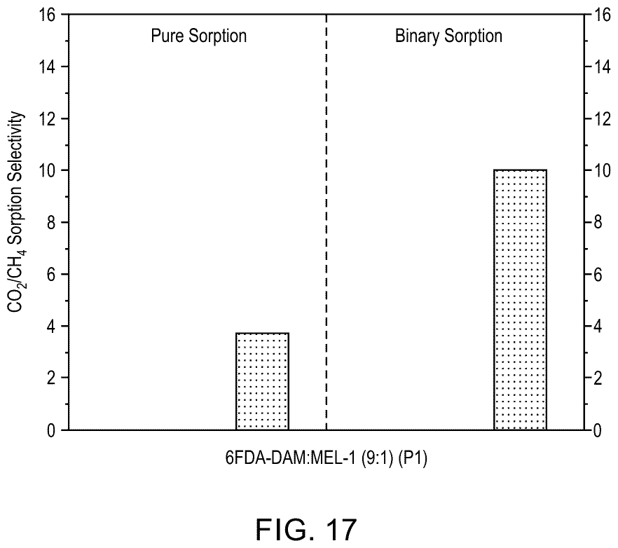

Pure gas transport performance usually does not match mixed gas performance for industrially relevant membrane applications. In general, idea selectivities were higher than mixed gas selectivities due to the swelling of the polymer in sour gas environment and plasticization effect. The melamine-containing copolyimide membranes of the present disclosure exhibited enhanced performance under high pressure and mixed gas testing conditions (Table 4 and Table 5) exceeding pure gas testing results (Table 3). This shows competitive sorption was established to enhance separation performance and increase mixed gas selectivities through the preparation of amine-functional microporous polymers. The mixed-gas sorption predictions and dual-model sorption (DMS) analysis further corroborated these findings as depicted in FIG. 17, which demonstrated higher sorption selectivity in mixed gas scenarios compared to pure gas. Therefore, the improvements in CO₂/CH₄ mixed gas selectivities observed with melamine-containing copolyimides of the present disclosure can likely be attributed to increased sorption selectivity to mixed gas conditions due to increased affinity to CO₂, highlighting the use of competitive sorption for mixed-gas performance enhancement for CO₂-based gas separations.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### EMBODIMENTS

Embodiment 1: A melamine-containing copolyimide comprising:
a structural repeat unit of Formula (I):

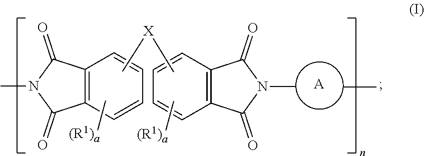

and
a structural repeat unit of Formula (II):

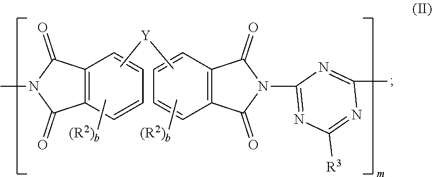

wherein:
Ring moiety A is selected from phenylene, biphenylene, terphenylene, and polycyclic aromatic hydrocarbon, wherein the phenylene, biphenylene, terphenylene, and polycyclic aromatic hydrocarbon are each optionally substituted with one, two, three, or four independently selected R⁴;
X and Y are each independently selected from a bond, —O—, —C(O)—, —O-phenyl-C₁₋₄ alkylene-phenyl-O—, and C₁₋₄ alkylene optionally substituted with one, two, three, or four independently selected R⁵;
each R¹ and R² is independently selected from halo,C₁₋₄ alkyl, and C₁₋₄ haloalkyl;
R³ is selected from H, —OH, halo, C₁₋₆ alkyl, C₁₋₆ haloalkyl, phenyl, C₁₋₄ alkyl-phenyl, C₃₋₂₀ cycloalkyl, C₆₋₂₀ aryl, C₆₋₂₀ heteroaryl, C₆₋₂₀ heterocycloalkyl, and —NR^{a}R^{b}, wherein R^{a} and R^{b} are each independently selected from H and C₁₋₆ alkyl, wherein the C₁₋₄ alkyl-phenyl, C₃₋₂₀ cycloalkyl, C₆₋₂₀ aryl, C₆₋₂₀ heteroaryl, and C₆₋₂₀ heterocycloalkyl are each optionally substituted with one, two, three, or four independently selected R⁶;
each R⁴, R⁵, and R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃;
a and b are each independently 0, 1, 2, or 3;
and m+n=1.
   Embodiment 2: The melamine-containing copolyimide of embodiment 1, wherein Ring moiety A is phenylene optionally substituted with one, two, three, or four independently selected R⁴.
   Embodiment 3: The melamine-containing copolyimide of embodiment 1 or 2, wherein each R⁴ is independently C₁₋₄ alkyl.
   Embodiment 4: The melamine-containing copolyimide of any one of embodiments 1-3, wherein X and Y are each methyl, each optionally substituted with one or two R⁵.
   Embodiment 5: The melamine-containing copolyimide of any one of embodiments 1-4, wherein each R⁵ is independently C₁ alkyl optionally substituted with one, two, or three R⁷, and each R⁷ is independently halo.
   Embodiment 6: The melamine-containing copolyimide of any one of embodiments 1-5, wherein X and Y are each methyl, wherein each methyl is substituted with two —CF₃.
   Embodiment 7: The melamine-containing copolyimide of any one of embodiments 1-6, wherein R³ is selected from H, —OH, halo, C₁₋₄ alkyl, phenyl, C₁₋₄ alkyl-phenyl, and C₆₋₂₀ heterocycloalkyl, wherein the C₁₋₄ alkyl-phenyl and C₆₋₂₀ heterocycloalkyl are each substituted with one, two, three, or four independently selected R⁶.
   Embodiment 8: The melamine-containing copolyimide of any one of embodiments 1-7, wherein a and b are each independently 0 or 1.
   Embodiment 9: The melamine-containing copolyimide of any one of embodiments 1-8, wherein m is between 0.05 to 0.2, and n is between 0.8 to 0.95.
   Embodiment 10: The melamine-containing copolyimide of any one of embodiments 1-9, wherein the melamine-containing copolyimide has a Formula (III):

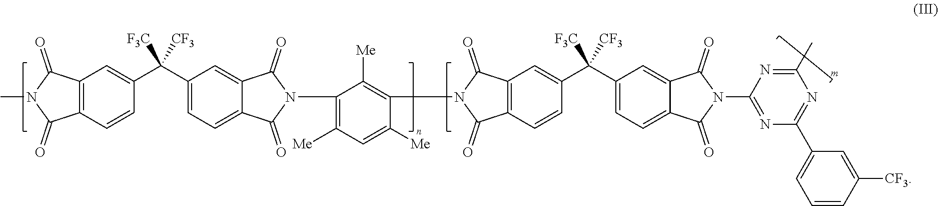

Embodiment 11: The melamine-containing copolyimide of any one of embodiments 1-10, wherein m is 0.1 and n is 0.9, and the melamine-containing copolyimide of Formula (III) has a number average molecular weight (Mn) of about 18 to about 26 kilograms per mole (kg/mol).
Embodiment 12: The melamine-containing copolyimide of any one of embodiments 1-11, wherein m is 0.1 and n is 0.9, and the melamine-containing copolyimide of Formula (III) has a weight average molecular weight (M_{w}) of about 31 to about 41 kg/mol.
Embodiment 13: The melamine-containing copolyimide of any one of embodiments 1-12, wherein m is 0.1 and n is 0.9, and the melamine-containing copolyimide of Formula (III) has a polydispersity index (PDI) of about 1.5 to about 1.9.
Embodiment 14: The melamine-containing copolyimide of any one of embodiments 1-13, wherein the melamine-containing copolyimide has a Formula (IV):

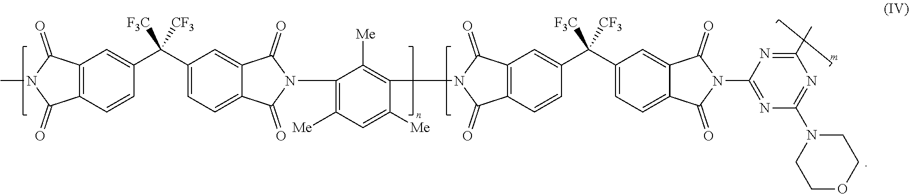

Embodiment 15: The melamine-containing copolyimide of any one of embodiments 1-14, wherein m is 0.1 and n is 0.9, and the melamine-containing copolyimide of Formula (IV) has a Mₙ of about 10 to about 18 kg/mol.
Embodiment 16: The melamine-containing copolyimide of any one of embodiments 1-15, wherein m is 0.1 and n is 0.9, and the melamine-containing copolyimide of Formula (IV) has a M_{w} of about 23 to about 33 kg/mol.
Embodiment 17: The melamine-containing copolyimide of any one of embodiments 1-16, wherein m is 0.1 and n is 0.9, and the melamine-containing copolyimide of Formula (IV) has a PDI of about 1.7 to about 2.1.
Embodiment 18: A membrane comprising the melamine-containing copolyimide of embodiment 1.
Embodiment 19: The membrane of embodiment 18, comprising at least about 80 wt. % of the melamine-containing copolyimide.
Embodiment 20: A method of separating carbon dioxide (CO₂) from a CO₂-containing gas mixture, the method comprising:
passing the CO₂-containing gas mixture through a melamine-containing copolyimide membrane comprising the melamine-containing copolyimide of embodiment 1 to form a purified gas by absorbing the CO₂ and allowing the CO₂-containing gas mixture to pass through the melamine-containing copolyimide membrane.
   Embodiment 21: The method of embodiment 20, wherein the CO₂-containing gas mixture further comprises one or more components selected from the group consisting of methane (CH₄), ethane (C₂H₆), propane (C₃H₈), butane (C₄H₁₀), nitrogen (N₂), hydrogen sulfide (H₂S), and water (H₂O) vapor.
   Embodiment 22: The method of embodiment 20 or 21, wherein the CO₂-containing gas mixture comprises CO₂ and CH₄.
   Embodiment 23: The method of any one of embodiments 20-22, wherein the CO₂-containing gas mixture is contacted with the melamine-containing copolyimide membrane at a temperature of about 20 to about 30° C. and a pressure of about 100 to about 800 pounds per square inch (psi).
   Embodiment 24: The method of any one of embodiments 20-23, wherein the CO₂-containing gas mixture comprises CO₂ and CH₄, and the method has a CO₂/CH₄ selectivity of about 38.8 at 25° C. and 100 psi.
   Embodiment 25: The method of any one of embodiments 20-24, further comprising preparing the melamine-containing copolyimide membrane by:
mixing the melamine-containing copolyimide of embodiment 1 in a solvent to form a mixture;
casting the mixture into a mold to form a sample; and drying the sample at a temperature of about 100 to about 180° C.
   Embodiment 26: The method of any one of embodiments 20-25, wherein the solvent is selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, and mixtures thereof.
   Embodiment 27: The method of any one of embodiments 20-26, further comprising preparing the melamine-containing copolyimide by:
mixing monomers of 4,4′-(hexafluoroisopropylidene)diphthalic anhydride (6FDA), an aromatic diamine, a melamine compound, and the solvent to form a first reaction mixture containing one or more polyamic acids;
mixing an amine base and an acetic anhydride to form a second mixture;
mixing the first reaction mixture and the second mixture, thereby reacting the one or more polyamic acids with the acetic anhydride to form a crude product mixture containing the melamine-containing copolyimide;
adding the crude product mixture into water to precipitate the melamine-containing copolyimide from the crude product mixture; and
removing the melamine-containing copolyimide from the crude product mixture, washing with water, and drying at a temperature of about 110 to about 200° C.
   Embodiment 28: The method of any one of embodiments 20-27, wherein the aromatic diamine is 2,4,6-trimethyl-m-phenylenediamine, and the melamine compound has a Formula (V)

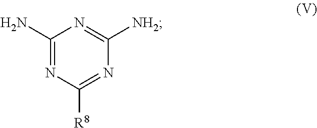

wherein R⁸ is selected from the group consisting of

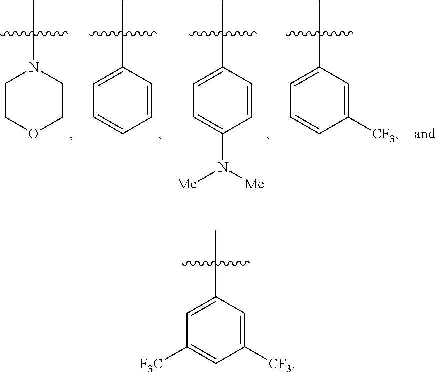

1. A melamine-containing copolyimide comprising:
a structural repeat unit of Formula (I): 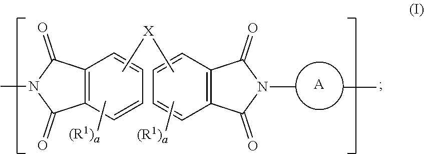
and
a structural repeat unit of Formula (II): 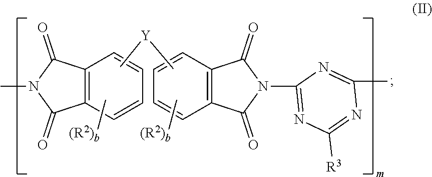
wherein:
Ring moiety A is selected from phenylene, biphenylene, terphenylene, and polycyclic aromatic hydrocarbon, wherein the phenylene, biphenylene, terphenylene, and polycyclic aromatic hydrocarbon are each optionally substituted with one, two, three, or four independently selected R⁴;
X and Y are each independently selected from a bond, —O—, —C(O)—, —O-phenyl-C₁₋₄ alkylene-phenyl-O—, and C₁₋₄ alkylene optionally substituted with one, two, three, or four independently selected R⁵;
each R¹ and R² is independently selected from halo,C₁₋₄ alkyl, and C₁₋₄ haloalkyl;
R³ is selected from H, —OH, halo, C₁₋₆ alkyl, C₁₋₆ haloalkyl, phenyl, C₁₋₄ alkyl-phenyl, C₃₋₂₀ cycloalkyl, C₆₋₂₀ aryl, C₆₋₂₀ heteroaryl, C₆₋₂₀ heterocycloalkyl, and —NR^{a}R^{b}, wherein R^{a} and R^{b} are each independently selected from H and C₁₋₆ alkyl, wherein the C₁₋₄ alkyl-phenyl, C₃₋₂₀ cycloalkyl, C₆₋₂₀ aryl, C₆₋₂₀ heteroaryl, and C₆₋₂₀ heterocycloalkyl are each optionally substituted with one, two, three, or four independently selected R⁶;
each R⁴, R⁵, and R⁶ is independently selected from hydrogen, halo, —OH, —NH₂, —SH, —C(O)OH, —N₃, and C₁₋₄ alkyl optionally substituted with one, two, three, or four independently selected R⁷, wherein each R⁷ is independently selected from hydrogen, halo, —OH, —NH₂, —SH, —C(O)OH, and —N₃;
a and b are each independently 0, 1, 2, or 3;
and m+n=1.

2. The melamine-containing copolyimide of claim 1, wherein Ring moiety A is phenylene optionally substituted with one, two, three, or four independently selected R⁴.

3. The melamine-containing copolyimide of claim 2, wherein each R⁴ is independently C₁₋₄ alkyl.

4. The melamine-containing copolyimide of claim 1, wherein X and Y are each methyl, each optionally substituted with one or two R⁵.

5. The melamine-containing copolyimide of claim 4, wherein each R⁵ is independently C₁ alkyl optionally substituted with one, two, or three R⁷, and each R⁷ is independently halo.

6. The melamine-containing copolyimide of claim 1, wherein X and Y are each methyl, wherein each methyl is substituted with two —CF₃.

7. The melamine-containing copolyimide of claim 1, wherein R³ is selected from H, —OH, halo, C₁₋₄ alkyl, phenyl, C₁₋₄ alkyl-phenyl, and C₆₋₂₀ heterocycloalkyl, wherein the C₁₋₄ alkyl-phenyl and C₆₋₂₀ heterocycloalkyl are each substituted with one, two, three, or four independently selected R⁶.

8. The melamine-containing copolyimide of claim 1, wherein a and b are each independently 0 or 1.

9. The melamine-containing copolyimide of claim 1, wherein m is between 0.05 to 0.2, and n is between 0.8 to 0.95.

10. The melamine-containing copolyimide of claim 1, wherein the melamine-containing copolyimide has a Formula (III):

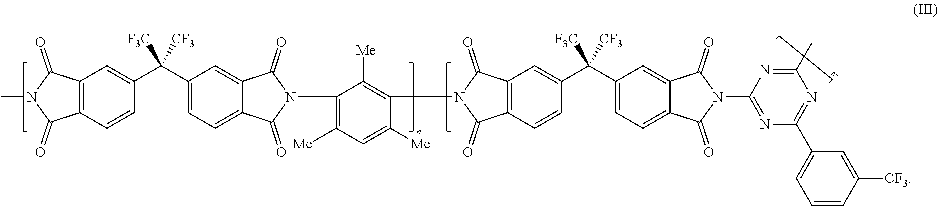

11. The melamine-containing copolyimide of claim 10, wherein m is 0.1 and n is 0.9, and the melamine-containing copolyimide of Formula (III) has a number average molecular weight (Mₙ) of about 18 to about 26 kilograms per mole (kg/mol).

12. The melamine-containing copolyimide of claim 10, wherein m is 0.1 and n is 0.9, and the melamine-containing copolyimide of Formula (III) has a weight average molecular weight (M_{w}) of about 31 to about 41 kg/mol.

13. The melamine-containing copolyimide of claim 10, wherein m is 0.1 and n is 0.9, and the melamine-containing copolyimide of Formula (III) has a polydispersity index (PDI) of about 1.5 to about 1.9.

14. The melamine-containing copolyimide of claim 1, wherein the melamine-containing copolyimide has a Formula (IV):

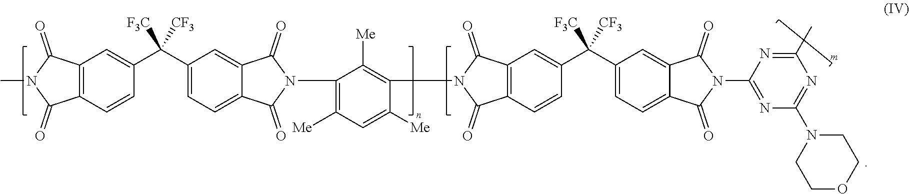

15. The melamine-containing copolyimide of claim 14, wherein m is 0.1 and n is 0.9, and the melamine-containing copolyimide of Formula (IV) has a Mₙ of about 10 to about 18 kg/mol.

16. The melamine-containing copolyimide of claim 14, wherein m is 0.1 and n is 0.9, and the melamine-containing copolyimide of Formula (IV) has a M_{w} of about 23 to about 33 kg/mol.

17. The melamine-containing copolyimide of claim 14, wherein m is 0.1 and n is 0.9, and the melamine-containing copolyimide of Formula (IV) has a PDI of about 1.7 to about 2.1.

18. A membrane comprising the melamine-containing copolyimide of claim 1.

19. The membrane of claim 18, comprising at least about 80 wt. % of the melamine-containing copolyimide.

20. A method of separating carbon dioxide (CO₂) from a CO₂-containing gas mixture, the method comprising:
passing the CO₂-containing gas mixture through a melamine-containing copolyimide membrane comprising the melamine-containing copolyimide of claim 1 to form a purified gas by absorbing the CO₂ and allowing the CO₂-containing gas mixture to pass through the melamine-containing copolyimide membrane.

21. The method of claim 20, wherein the CO₂-containing gas mixture further comprises one or more components selected from the group consisting of methane (CH₄), ethane (C₂H₆), propane (C₃H₈), butane (C₄H₁₀), nitrogen (N₂), hydrogen sulfide (H₂S), and water (H₂O) vapor.

22. The method of claim 20, wherein the CO₂-containing gas mixture comprises CO₂ and CH₄.

23. The method of claim 20, wherein the CO₂-containing gas mixture is contacted with the melamine-containing copolyimide membrane at a temperature of about 20 to about 30° C. and a pressure of about 100 to about 800 pounds per square inch (psi).

24. The method of claim 20, wherein the CO₂-containing gas mixture comprises CO₂ and CH₄, and the method has a CO₂/CH₄ selectivity of about 38.8 at 25° C. and 100 psi.

25. The method of claim 20, further comprising preparing the melamine-containing copolyimide membrane by:
mixing the melamine-containing copolyimide of claim 1 in a solvent to form a mixture;
casting the mixture into a mold to form a sample; and
drying the sample at a temperature of about 100 to about 180° C.

26. The method of claim 25, wherein the solvent is selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, and mixtures thereof.

27. The method of claim 25, further comprising preparing the melamine-containing copolyimide by:
mixing monomers of 4,4′-(hexafluoroisopropylidene)diphthalic anhydride (6FDA), an aromatic diamine, a melamine compound, and the solvent to form a first reaction mixture containing one or more polyamic acids;
mixing an amine base and an acetic anhydride to form a second mixture;
mixing the first reaction mixture and the second mixture, thereby reacting the one or more polyamic acids with the acetic anhydride to form a crude product mixture containing the melamine-containing copolyimide;
adding the crude product mixture into water to precipitate the melamine-containing copolyimide from the crude product mixture; and
removing the melamine-containing copolyimide from the crude product mixture, washing with water, and drying at a temperature of about 110 to about 200° C.

28. The method of claim 27, wherein the aromatic diamine is 2,4,6-trimethyl-m-phenylenediamine, and the melamine compound has a Formula (V) 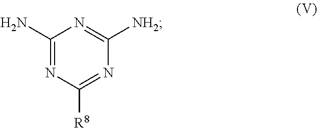
wherein R⁸ is selected from the group consisting of [chemical structure]
